(19) United States
(12) Patent Application Publication
(10) Pub. No.: US 2024/0175847 A1
(43) Pub. Date: May 30, 2024

(54) SEAL FAILURE DETECTION SYSTEM AND METHODS

(71) Applicant: Cepheid, Sunnyvale, CA (US)

(72) Inventors: Aristotelis Fotkatzikis, Sunnyvale, CA (US); Vijay Venugopal, Sunnyvale, CA (US); Melanie Senn, Sunnyvale, CA (US); Koohong Chung, Sunnyvale, CA (US); Robel Fessehatzion, Sunnyvale, CA (US); Percy B. Burnett, Sunnyvale, CA (US)

(21) Appl. No.: 18/460,253

(22) Filed: Sep. 1, 2023

Related U.S. Application Data
(60) Provisional application No. 63/374,313, filed on Sep. 1, 2022.

(51) Int. Cl. G01N 29/04; B23K 20/10; G01N 21/90; G06T 7/00

(52) U.S. Cl. CPC G01N 29/04; B23K 20/10; G01N 21/90; G06T 7/001; G01N 2291/023; G01N 2291/267; G06T 2207/10024; G06T 2207/10048; G06T 2207/20081

(57) ABSTRACT

Methods and systems for detecting defect in sample cartridges in real-time during manufacturing. Such systems utilize one or more external sensors that detect characteristics or parameters of the sample cartridge and/or the manufacturing process from one or more data sets. The external sensor(s) include any of: an RGB camera, IR camera, high-resolution optical camera, and ultrasonic microphone or combination thereof. An automated system obtains data sets from external sensor(s) and compares the data sets to a baseline of the sample cartridge and/or manufacturing process such that defects can be determined based on a variance from the baseline. Such methods can utilize feature extraction and spectrum analysis to identify features or characteristics for comparison with the baseline. A machine learning model can be used to determine an algorithm based on data sets of acceptable sample cartridges and data sets from the external sensor(s) that are associated with the cartridge defect.

### CROSS-REFERENCES TO RELATED APPLICATIONS

This application is a Non-Provisional of and claims the benefit of priority of U.S. Provisional Application No. 63/374,313 filed Sep. 1, 2022, which is incorporated herein by reference.

This application is generally related to U.S. Non-Provisional application Ser. No. 18/460,266 entitled “FAULTY UNIT DETECTION SYSTEM AND METHODS” and U.S. Non-Provisional application Ser. No. 18/460,279 entitled “TRANSFER LEARNING METHODS AND MODELS FACILITATING DEFECT DETECTION,” each filed Sep. 9, 2023, the entire contents of which are incorporated herein by reference for all purposes.

### FIELD OF THE INVENTION

The present invention relates generally to the field of manufacturing of biological equipment, in particular defect detection of sample cartridges for analysis of a fluid sample.

### BACKGROUND OF THE INVENTION

In recent years, there has been considerable development in the field of biological testing devices that facilitate manipulate a fluid sample within a sample cartridge for biological testing of a fluid sample by nucleic acid amplification testing (NAAT). One notable development in this field is the GeneXpert sample cartridge by Cepheid. The configuration and operation of these types of cartridges can be further understood by referring to U.S. Pat. No. 6,374,684 entitled “Fluid Control and Processing System,” and U.S. Pat. No. 8,048,386 entitled “Fluid Processing and Control.” While these sample cartridges represent a considerable advancement in the state of the art, as with any precision instrument, there are certain challenges in regard to manufacturing of the sample cartridge, in particular the assembly of multiple components in a precision, pressurized instrument can occasionally result in defects that cause sample cartridges to leak or unable to maintain internal pressure needed for successful operation.

Conventional systems for manufacturing sample cartridges utilize a series of manufacturing process and steps, some of which employ processes that can introduce defects into the sample cartridge, for example defects that cause the sample cartridge to leak or unable to maintain internal pressure, commonly known as seal failures. Certain steps, such as welding of a lid apparatus onto a cartridge body and film sealing of reagents in the cartridge, can introduce defects in sealing that are difficult to detect. Existing approaches to detecting these defects include various seal testing approaches and visual inspections, however, these approaches often utilize destructive methods and/or occasionally fail to identify all defects. Further, these approaches often test a number of cartridges in a certain lot, and if unacceptable defects are detected, the entire lot is scrapped to ensure defective cartridges do not reach the end user. Additionally, current inspection methods are not always consistent due to human error.

Accordingly, there exists a need for improved methods of defect detection to improve consistency in the manufacturing process and to avoid unnecessary waste. In particular, there is a need for such methods that are non-destructive, do not require extensive testing post-manufacture, and are not prone to human errors associated with visual inspection methods.

### BRIEF SUMMARY OF THE INVENTION

In one aspect, the invention pertains to methods of detecting a defect in a sample cartridge. Such methods can include steps of: obtaining one or more data sets from one or more external sensors during a manufacturing process of a sample cartridge; comparing one or more data sets to a baseline data set of the manufacturing process and/or sample cartridge, the baseline being associated with acceptable sample cartridges; and identifying a defect of the sample cartridge based on a variance of the one or more data sets from the baseline. The defect can be determined in an automated process in real-time during manufacturing of the sample cartridge. In some embodiments, obtaining one or more data sets includes obtaining multiple images from one or more RGB cameras and/or IR cameras, where the one or more data sets include a thermal image. In some embodiments, identifying the defect is based on a variance that utilizes an algorithm derived by a machine learning model based on a plurality of data sets associated with acceptable sample cartridges and a plurality of data sets associated with cartridge defects. In some embodiments, the methods include extracting a feature from one or more images that correspond to features of the sample cartridge. In some embodiments, the one or more data sets include multiple consecutive images obtained during the manufacturing process, which can include images from multiple locations and differing viewpoints. In some embodiments, the algorithm matches data from different sources and provides time series data processing to facilitate defect detection. In some embodiments, the one or more data sets are associated with a cartridge defect by utilizing an algorithm determined by a machine learning model, which can include any of: deep learning, supervised learning and unsupervised learning. In some embodiments, the automated method is performed during a manufacturing/assembly process, such as the reagents-on-board automated line (ROBAL), so as to detect any defects in the cartridge, lid or film seal by the described methods in real-time.

In some embodiments, the manufacturing process includes ultrasonic welding of a lid apparatus on a cartridge body of the sample cartridge. In some embodiments, the manufacturing process includes ultrasonically welding internal components of the cartridge within the cartridge body during manufacture. In some embodiments, the manufacturing process comprises heat sealing of a thin film atop the lid apparatus on the cartridge body of the sample cartridge. In some embodiments, the manufacturing process includes sealing a film (via heat sealing or ultrasonic welding) to isolate a reagent containing chamber within the cartridge prior to securing the lid to the cartridge body. The one or more external sensors can include an RGB camera, an IR camera or a combination thereof disposed at one or more locations along the sample cartridge manufacturing line. In some embodiments, the one or more external sensors comprise an ultrasound microphone. In such embodiments, the one or more data sets further include an ultrasound audio spectrum that is compared to a baseline of ultrasound audio of a successful weld, where the characteristic can be peaks and/or variations in the ultrasound audio spectrum. In other embodiments, the one or more external sensors include a high-resolution camera that obtains a high-resolution optical image. In such embodiments, the variance can be a deviation of an extracted feature from a corresponding feature of a baseline high-resolution image.

In another aspect, the invention pertains to a system for detecting a defect in a sample cartridge. Such systems can include: one or more external sensors disposed at or adjacent a manufacturing process station of a sample cartridge manufacturing line, where the one or more external sensors include any of: an RGB camera, an IR camera, or a combination thereof; and a processing unit operably coupled to the one or more external sensors and communicatively coupled with a control unit of automated manufacturing equipment of the manufacturing line. The processing unit has recorded thereon instructions for performing automated defect detection of the sample cartridge, which can includes steps of: obtaining one or more data sets from the one or more external sensors during a manufacturing process of a sample cartridge; comparing the one or more data sets to a baseline data set of the manufacturing process and/or sample cartridge, the baseline being associated with acceptable sample cartridges; and identifying a defect of the sample cartridge based on a variance of the one or more data sets from the baseline. The processing unit can be configured such that the defect detection is determined in real-time during manufacturing of the sample cartridge.

In some embodiments, the processing unit is further configured such that obtaining one or more data sets includes obtaining images from one or more RGB cameras and/or IR cameras, where the one or more data sets are one or more thermal images. The processing unit can be further configured such that identifying based on a variance utilizes an algorithm derived by machine learning based on multiple data sets associated with acceptable sample cartridges and multiple data sets associated with cartridge defects. In some embodiments, the processing unit can be further configured to extract one or more features from the one or more images that corresponds to standard features of the sample cartridge. The one or more data sets can include multiple consecutive images obtained during the manufacturing process, which can be obtained from differing locations and/or viewpoints. In some embodiments, the manufacturing process includes ultrasonic welding of a lid apparatus on a cartridge body of the sample cartridge. In some embodiments, the manufacturing process includes ultrasonically welding internal cartridge components inside the cartridge body during manufacture. In some embodiments, the manufacturing process includes isolating or sealing one or more internal reagent containing chambers within the cartridge with a film material using either heat sealing or ultrasonic welding. In some embodiments, the manufacturing process includes heat sealing of a thin film atop the lid apparatus on the cartridge body of the sample cartridge. The automated defect detection system can be integrated within automated software controlling the manufacturing line. In some embodiments, the defect detection can be integrated with the automated manufacturing line of the cartridge (e.g. ROBAL). In some embodiments, the defection detection is performed by inputting automated parameters and/or outputs from one or more external sensors into a pre-trained model, the model being trained by machine learning. In some embodiments, the model is trained by using both supervised and unsupervised learning. In some embodiments, the model accesses data sets for defect detection, which can include the operational parameters and/or output from the one or more external sensors, through a cloud-based server or cloud-based data sharing platform, which allows defection detection to be highly scaled for training and/or use across multiple manufacturing lines.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a flowchart demonstrating a defect detection approach that utilizes manufacturing parameter inputs fed into a machine learning model to facilitate classification of a manufactured product, in accordance with some embodiments.

FIG. 1B is a flowchart demonstrating a defect detection approach that utilizes manufacturing parameter inputs fed as labels into a machine learning model, utilizing both supervised and unsupervised learning, to facilitate classification of a manufactured product, in accordance with some embodiments.

FIG. 1C is an overview schematic showing a system setup to facilitate automated defect detection, in accordance with some embodiments.

FIG. 1D is a schematic of the data flow having cloud-based storage and data sharing for high scalability for training the model, in accordance with some embodiments.

FIG. 1E is another flowchart demonstrating a defect detection approach utilizing images and parameters input into a machine learning model to facilitate classification of a manufactured product, in accordance with some embodiments.

FIG. 2A illustrates an exemplary sample cartridge having a welded lid apparatus and film seal, as provided to the user, with the lid in the top lid open for receiving a fluid sample.

FIG. 2B illustrates an exploded view of the sample cartridge illustrating its major components, including the lid apparatus, multi-chamber body, reaction vessel, valve assembly and base, in accordance with some embodiments. FIGS. 2C-2D show a detail view of the lid apparatus. FIG. 2E shows the lid apparatus before placement atop the sample cartridge body for ultrasonic welding by the welding horn. FIG. 2F shows a schematic of a portion of the manufacturing line process of particular relevance to the image detection methods described herein.

FIGS. 3A-1 to 3A-6 illustrates a manufacturing process flow chart and identifies various sources of seal test failures in an exemplary manufacturing method of sample cartridges.

FIGS. 3B-1 to 3B-3 illustrates the manufacturing process flow of FIG. 3A-1 with additional external sensors added to obtain parameters for automated defect detection, in accordance with some embodiments.

FIG. 4 illustrates a data collection flowchart during a manufacturing process including parameters that can be utilizing in automated defect detection, in accordance with some embodiments.

FIGS. 5A-5D show exemplary infrared thermal images obtained during the manufacturing process to facilitate automated defect detection, including an image obtained during the film seal in FIG. 5A and during the welder process shown in FIG. 5B. FIG. 5E illustrates a flowchart in which images and potentially additional parameters are fed into a deep learning model, in accordance with some embodiments.

FIGS. 6A-6D show exemplary infrared thermal images obtained during the manufacturing process to facilitate automated defect detection by image matching, in accordance with some embodiments.

FIG. 7 shows an IR camera sensor added adjacent a welding station in a sample cartridge manufacturing station to obtain IR images for automated defect detection, in accordance with some embodiments.

FIGS. 8A-8D, 9A-9C, 10A-10D, and 11A-11C show exemplary infrared thermal images obtained during a welding manufacturing process at different points in time to facilitate automated defect detection, in accordance with some embodiments.

FIGS. 12A-12B shows an ultrasound microphone sensor added adjacent a sample cartridge manufacturing station to obtain audio of manufacturing process for automated defect detection, in accordance with some embodiments.

FIGS. 13, 14A-1, 14A-2, 14B-1, 14B-2, 15A-15B, 16A and 16B show exemplary ultrasonic audio spectrums obtained during a welding process to facilitate automated defect detection, in accordance with some embodiments.

FIGS. 17A-17E shows an optical camera positioned for capturing high-resolution images of a manufactured sample cartridge, and high-resolution optical images for automated defect detection, in accordance with some embodiments.

FIGS. 18A-18D shows top-down optical images for assessing lid alignment for automated defect detection, in accordance with some embodiments.

FIG. 19A shows a welding station with perspective view IR and RGB cameras and an overhead view RGB camera, in accordance with some embodiments.

FIGS. 19B-19E show an IR image of a baseline and various cartridge defects, in accordance with some embodiments.

FIG. 20 shows experimental results of image-based defect detection versus human inspection, in accordance with some embodiments.

FIGS. 21A-1 to 21A-3, 21B-1 to 21B-3, and 21C-1 to 21C-3 show RGB images, IR images and computer vision features based on IR images associated with various cartridge defects after welding, in accordance with some embodiments.

FIGS. 22A-22B show IR images of film seal defects, in accordance with some embodiments.

FIGS. 23A-1 and 23A-2 shows microscopy images of the film seal and FIGS. 23B-1 and 23B-2 shows IR images of the film seal for defect detection, in accordance with some embodiments.

FIGS. 24A-24B shows RGB and IR images indicated a melted chimney defect, in accordance with some embodiments.

FIGS. 25A-25B show flowcharts of automated defect detection, in accordance with some embodiments.

FIG. 26 shows a conventional infrastructure that can incorporate aspects of automated defect detection, in accordance with some embodiments.

FIG. 27 shows an updated infrastructure configured for integration of automatic defect detection, in accordance with some embodiments.

### DETAILED DESCRIPTION OF THE INVENTION

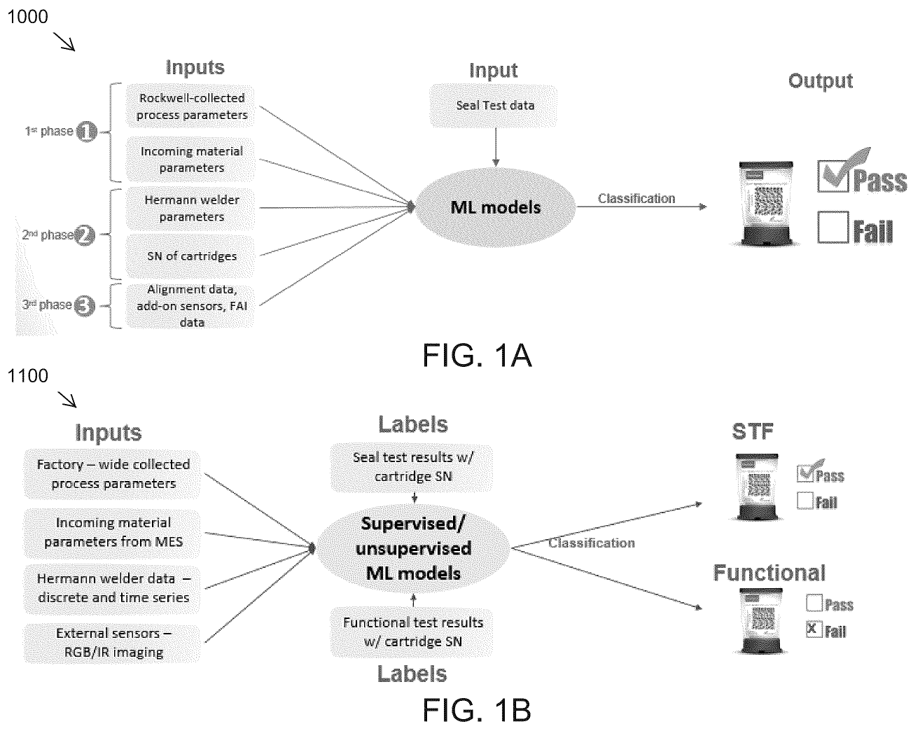

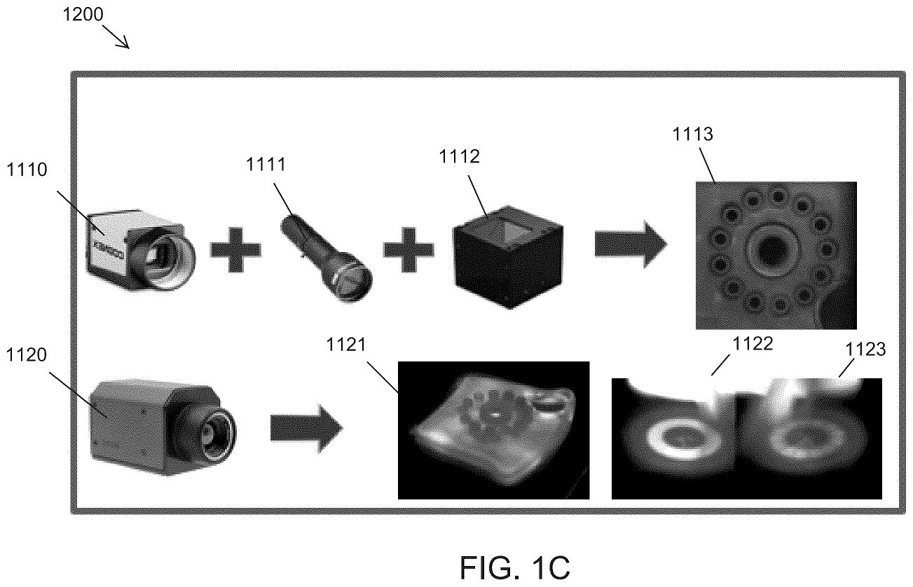

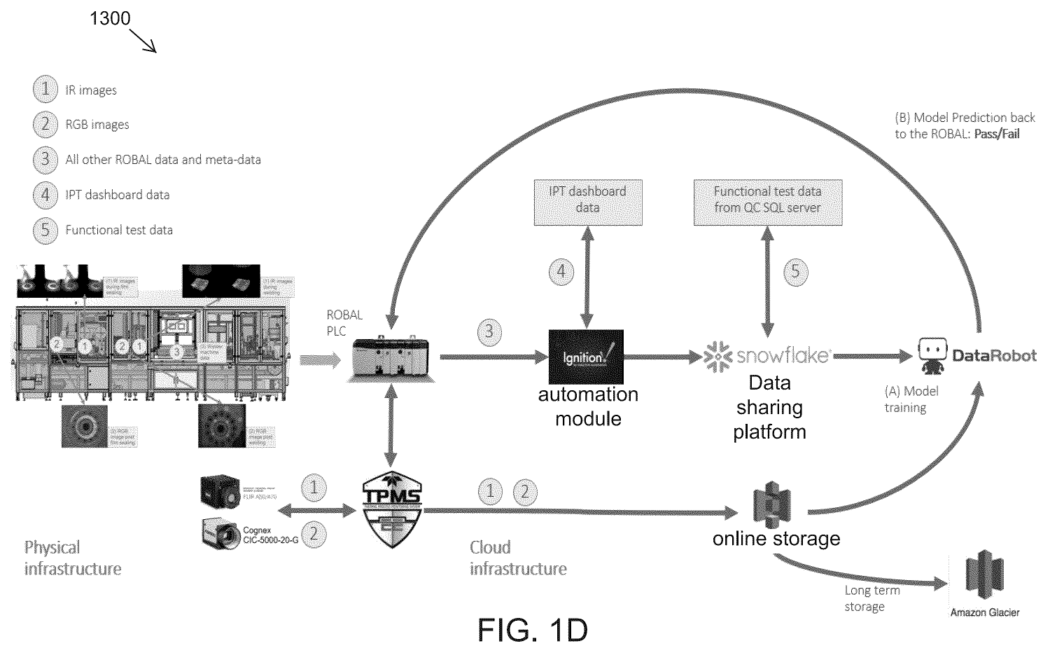

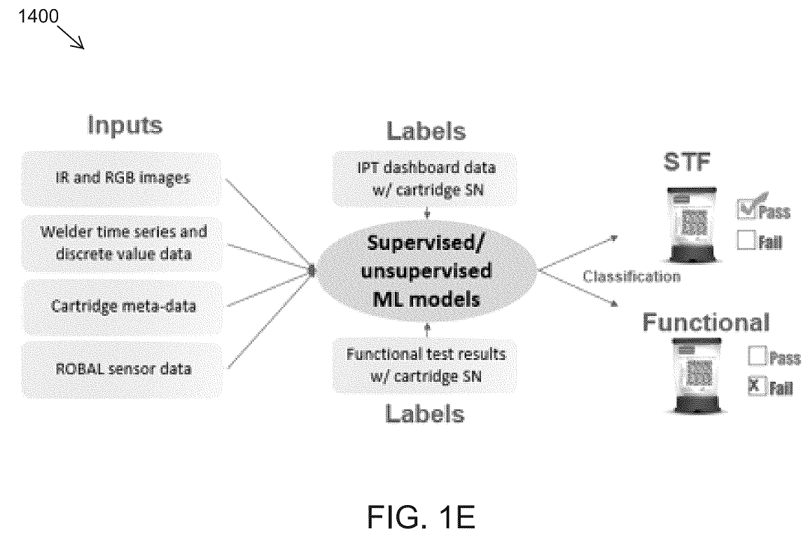

The present invention relates generally to manufacturing defect detection, in particular defect detection of sample cartridge during manufacturing. In some embodiments, the methods and systems provide automated defect detection that is performed in real-time during manufacturing. Flowcharts of such automated detection methods are shown in FIG. 1A-1B discussed in further detail below.

### I. System Overview

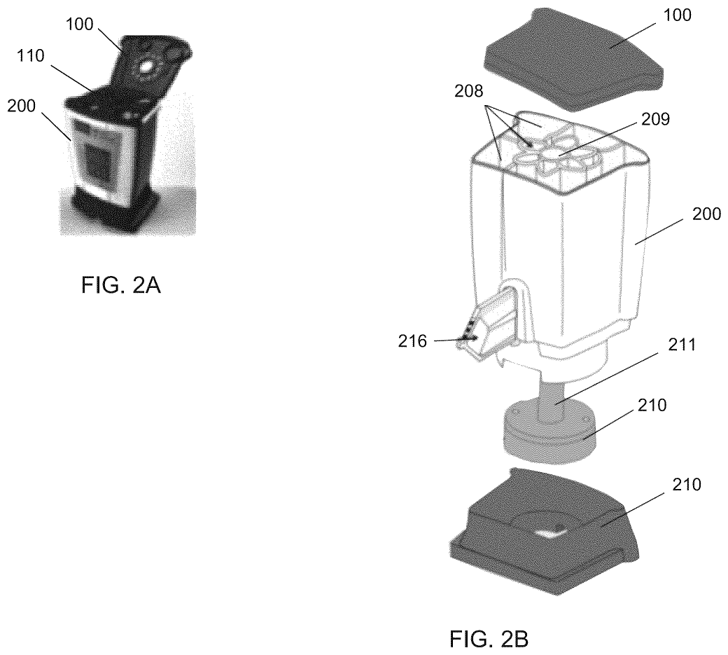

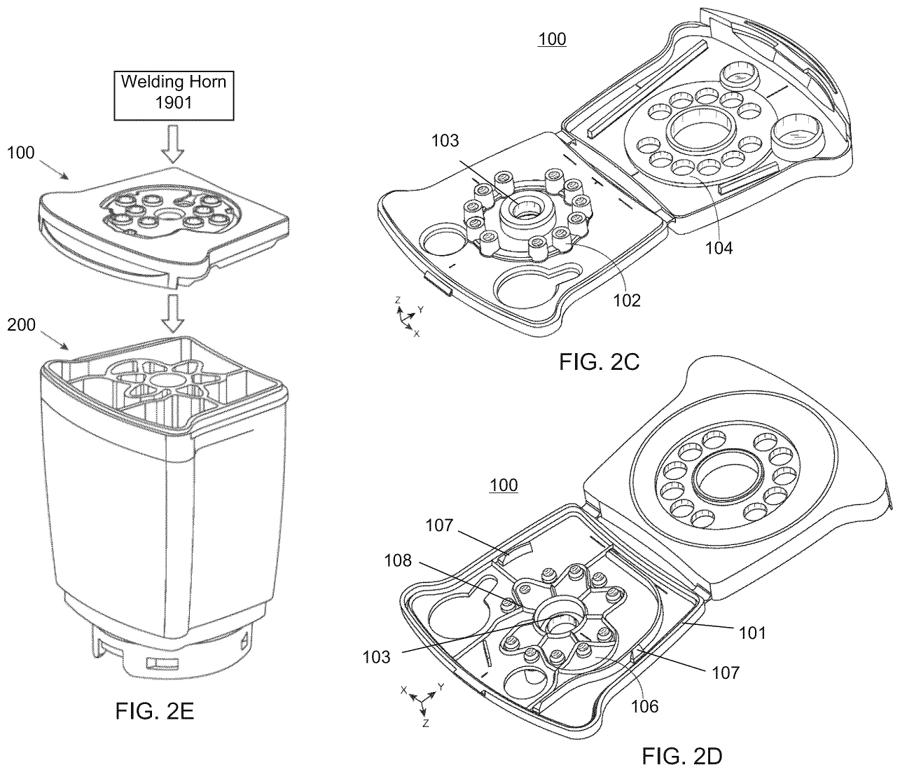

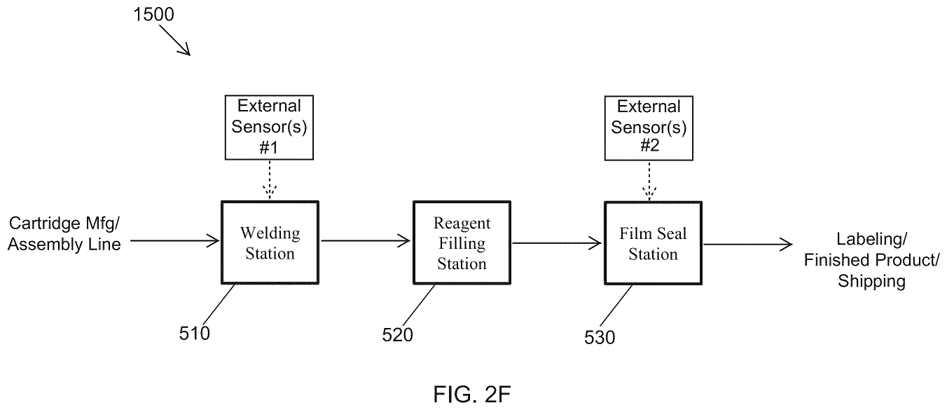

In one aspect, the invention pertains to an automated defect detection system for detecting defects in manufacturing of a sample cartridge for analyzing a sample for a target analyte. An exemplary sample cartridge is shown in FIG. 2A. The sample cartridge includes a lid apparatus 100 sealed atop the cartridge body 200 that holds the reagents and fluid sample. The lid apparatus 100 includes a bottom lid portion that is sealed to the cartridge body and a top lid portion that flips open, as shown, to allow the user to deposit a fluid sample in the cartridge. The sample cartridge is provided to the user having reagents already disposed within selected chambers and sealed within the cartridge by a thin film 110 sealed atop the bottom lid. The thin film includes a central opening for the syringe and an opening for insertion of the fluid sample.

FIG. 2B depicts an exemplary diagnostic assay cartridge suitable for performing nucleic acid amplification testing. The illustrated cartridges are based on the GENEXPERT® cartridge (Cepheid, Inc., Sunnyvale, Calif.). The cartridge 100 comprises a cartridge body 200 having multiple chambers 208 defined therien for holding various reagent and/or buffers. The chambers are disposed around a central syringe barrel 209 that is in fluid communication with valve body 210 through valve syringe tube 211 extending through the syringe barrel 209. The valve body 210 is interfaced within the cartridge body and supported on a cartridge base 210. The cartridge typically contains one or more channels or cavities that can contain a filter material (e.g. glass filter column) that can function to bind and elute a nucleic acid. In various embodiments, the cartridge further comprises one or more temperature controlled channels or chambers that can, in certain embodiments, function as amplification chambers for nucleic acid amplification via polymerase chain reaction (PCR), isothermal amplification, and the like. A “plunger” not shown can be operated to draw fluid into the syringe barrel 209 and rotation of the valve body/syringe tube provides selective fluid communication between the various reagent chambers, channels, and reaction chamber(s). Thus, the various reagent chambers, reaction chambers, matrix material(s), and channels are selectively in fluid communication by rotation of the valve, the plunger, and reagent movement (e.g., chamber loading or unloading) is operated by the “syringe” action of the plunger. The attached reaction vessel 216 (“PCR tube”) provides optical windows to provide real-time detection of, e.g., amplification products by operation of the module within the system described herein. It is appreciated that such a reaction vessel could include various differing chambers, conduits, or micro-well arrays for use in detecting the target analyte. The sample cartridge can be provided with means to perform preparation of the biological fluid sample before transport into the reaction vessel. Any chemical reagent required for viral or cell lysis, or means for binding or detecting an analyte of interest (e.g. reagent beads, filter material, and the like) can be contained within one or more chambers of the sample cartridge, and as such can be used for sample preparation.

An exemplary use of such a sample cartridge with a reaction vessel for analyzing a biological fluid sample is described in commonly assigned U.S. Pat. No. 6,818,185, entitled “Cartridge for Conducting a Chemical Reaction,” filed May 30, 2000, the entire contents of which are incorporated herein by reference for all purposes. Examples of the sample cartridge and associated instrument module are shown and described in U.S. Pat. No. 6,374,684, entitled “Fluid Control and Processing System” filed Aug. 25, 2000, and U.S. Pat. No. 8,048,386, entitled “Fluid Processing and Control,” filed Feb. 25, 2002, the entire contents of which are incorporated herein by reference in their entirety for all purposes. Various aspects of the sample cartridge can be further understood by referring to U.S. Pat. No. 6,374,684, which described certain aspects of a sample cartridge in greater detail. Such sample cartridges can include a fluid control mechanism, such as a rotary fluid control valve, that is connected to the chambers of the sample cartridge. Rotation of the rotary fluid control valve permits fluidic communication between chambers and the valve so as to control flow of a biological fluid sample deposited in the cartridge into different chambers in which various reagents can be provided according to a particular protocol as needed to prepare the biological fluid sample for analysis. To operate the rotary valve, the cartridge processing module comprises a motor such as a stepper motor typically coupled to a drive train that engages with a feature of the valve to control movement of the valve in coordination with movement of the syringe, thereby resulting in movement of the fluid sample according to the desired sample preparation protocol. The fluid metering and distribution function of the rotary valve according to a particular sample preparation protocol is demonstrated in U.S. Pat. No. 6,374,684.

FIGS. 2C-2D shows a detailed view of the exemplary lid apparatus 100, which includes a central opening for passage of the syringe/plunger, which effects movement of fluids between the chambers, and the central opening is surrounding by a plurality of chimneys 102 (with passages) that protrude into openings 104 in the top lid. Accordingly, the lid apparatus 100 includes a substantially uniform bottom-surface 106, and thus the shown inner welding pattern is not coextensive with any walls that extend from the bottom-surface 106. The chambers of the fluid container apparatus disclosed herein can contain one or more reagents for a variety of purposes. These reagents maybe present in a variety of forms. Non-limiting exemplary reagent forms can include a solution, a dry powder, or a lyophilized bead. The reagents may be intended for different purposes including but not limited to chemical and/or enzymatic reactions, sample preparation, and/or detection. Non-limiting exemplary purposes can include lysis of cells or microorganisms, purification or isolation of an analyte of interest (e.g., a specific cell population, a nucleic acid or a protein), digestion or modification of nucleic acids or proteins, amplification of nucleic acids, and/or detection of an analyte of interest. Additional details of the lid apparatus can be found in U.S. Pat. No. 10,273,062, the entire contents of which are incorporated herein by reference for all purposes.

FIG. 2C shows a top view of the lower-side of bottom-lid and underside of the top-lid portion. The lower-side of bottom-lid includes a plurality of chimneys 102 that protrude upwards from the top surface of the bottom-lid portion and are received in corresponding holes 104 in the top-lid portion. The plurality of chimneys 102 and openings 104 surround a central opening 103 through which a syringe instrument of the module extends during operation of the sample cartridge therein to facilitate fluid flow between the chambers by movement of the valve body. FIG. 2D shows a bottom view of the lower-side of bottom-lid of lid apparatus 100, which includes a lower-side main surface, and a top-side of the top-lid portion. The underside of the bottom-lid portion is welded onto the top edge of the cartridge body. To facilitate welding, a raised welding ridge 101 is continuous about the periphery of the bottom-lid, between the edge alignment features 107 and the outermost wall. When seated in a proper fashion, the edge alignment features 107 and outermost walls prevent excessive rotation of the bottom-lid against the fluid container 200, thus aligning the raised welding ridge 101 of the bottom-lid with weldable features (e.g., top edges of walls) of the cartridge body. A plurality of walls 108 extend from a central portion of the lower-side main surface. The walls are patterned in a flower petal-like arrangement, about the central opening 103. Here, the walls are formed as six petals. A raised welding pattern is present on the top edges of the walls. The raised welding pattern connects to the welding ridge 101. In this manner, fluidic zones are created outside the petals. When a fluid container and the bottom-lid are welded via the raised welding pattern and welding ridge, sub-containers within the bottom container are fluidly isolated from one another (at least at the interface between the fluid container and the bottom-cap).

FIG. 2E shows the lid apparatus 100 in relation to the cartridge body 200. The cartridge body 200 contains a plurality of chambers that can be fluidly coupled or non-coupled according to the position of an internal valve assembly. The chambers are defined by walls that extend to the top of the cartridge body 200. The fused interface between the lid apparatus 100 and the cartridge body 200 is created such that the chambers are sealed off from one another by way of a welded interface between the raised welding pattern 160 and welding ridge 156 and the chambers of the container 200. The lid apparatus 100 is welded to the fluid container by way of an ultrasonic welding horn 1901 that interfaces with the plateau 120 while the apparatus is seated on the container 200. The welding horn 1901 generally comprises a metal cylinder shaped to interface against and around the plateau. The welding horn is part of a greater welding apparatus (not shown) which provides energy to the horn. A commercially available ultrasonic welding apparatus is available from manufactures such as Hermann Ultrasonics, Bartlett, Ill. 60103 or Branson Ultrasonics, a division of Emerson Industrial Automation, Eden Prairie, Minn. 55344, can be used in this process. Typically, the welding operation described above is performed at a welding station along the manufacturing/production line of the sample cartridge.

FIG. 2F shows a schematic 1500 of a portion of the cartridge manufacturing/assembly line that includes the welding station 510, reagent filling station 520, and the film seal station 530. At the welding station 510, automated equipment places the lid apparatus 100 atop the cartridge body 200 and an ultrasonic horn is pressed down and ultrasonic energy is applied for up to 5 seconds (e.g. at least 3-5 seconds) so as to weld the lid to the cartridge body by ultrasonic welding. As described above, the welding ridges on the underside of the bottom lid are shaped and designed to be sealingly welded to the top edges of the cartridge body chambers. An external sensor #1 can be used to monitor a parameter/characteristic during welding, as described herein, such that the sensor output can be used to assess the weld. After welding, the cartridge is moved in an automated sequence to the reagent filling station 520 where one or more reagents (e.g. beads/fluids/powder) or processing materials are deposited in select chambers through the chimney openings in the lid. After the reagents or other compounds are placed in the chambers, the cartridge is moved to the film seal station 530 where a thin film seal is applied to the top surface of the bottom lid so as to seal the chimney passage openings, thereby sealing the reagents and process materials inside the cartridge. Automated equipment places the thin film atop the top lid (the lid being in the closed configuration) and applies heat so as to seal the thin film onto the lid. An external sensor #2 can be used to monitor a parameter/characteristic during sealing, as described herein, such that the sensor output can be used to assess the film seal. In some embodiments, the thin film is ultrasonically welded to the top of the lid. The thin film includes a central aperture (e.g. cross-cut) to allow passage of the syringe instrument through the film, and another opening on the lower right to allow injection of the fluid sample by the user into a sample chamber, however, the remaining openings in the lid that include the chimney openings to the reagent chambers are sealed by the thin film seal. As described further below, the automated defect detection system utilizes one or more external sensors (external sensor #1) 2) disposed at or adjacent to the welding station 510 and/or one or more external sensors (external sensor #2) disposed at or adjacent the film seal station 530 to assess the integrity of the lid construction after welding, or the integrity of the weld and/or film seal.

### II. Example Defect Detection Methods

### A. Overview

In one aspect, the system and methods described herein utilize one or more external sensors disposed at one or more locations along the manufacturing production line to obtain additional data sets of parameters regarding the manufacturing process or cartridge component attributes during manufacturing so as to detect defects in-real time during manufacturing. The external sensors can include, but are not limited to, any of high-resolution RGB or IR cameras, ultrasonic microphones or any combination thereof. In some embodiments, the IR cameras are configured to obtain a thermal distribution of the lid during the ultrasonic welding or of the film during or after heat sealing of the film. Given the complexity of the data and the limited amount of data associated with defects (which are relatively infrequent), it is advantageous to utilize a machine learning (ML) model to determine a relationship between one or more characteristics or parameters of the data sets from the external sensors and a cartridge defect. By utilizing a ML model, subtle variations in temperature distribution, image matching or an audio trace can be associated with defects that could otherwise not be detected by visual inspection or standard testing approaches. Advantageously, this automated defect detection allows for detection of defects in real-time during manufacturing, so the cartridge can be removed during manufacturing. In some embodiments, the automated defect detection avoids the need to conduct destructive post-manufacturing testing on select cartridge from each lot, particularly destructive testing, thereby avoiding waste and reducing costs, while considerably improving defect detection.

### B. Examples Seal Defect Detection Methods

In one aspect, the automated process uses ML models that associates one or more parameters or characteristics of a manufacturing process and/or product component with a particular defect. In some embodiments, the defects are associated with welded seals (e.g. overweld, underweld, cracked chimney) and/or film seals (e.g. incomplete seal, melted chimney). The parameters or characteristics can include any attribute associated with the manufacturing process or a product component. Advantageously, this approach allows for defect detection in real-time during the manufacturing process such that the defective cartridges can be removed mid-process.

As shown in FIG. 1A, which shows a flowchart schematic 1000, the automated method can include obtaining one or more inputs of any number of parameters associated with manufacturing methods and processes. In this embodiment, the parameters can be associated with a first phase of manufacturing (e.g. automation control-collected process parameters, such as incoming material parameters), a second phase (e.g. welding parameters, cartridge parameters, such as lot number or serial numbers), or a third phase (e.g. alignment data, sensor data, first article inspection (FAI) data). These one or more inputs are fed into a ML model that analyzes the various input in combination with actual testing data (e.g. seal testing data) to determine an association between the one or more parameters/characteristics and a respective defect. The ML model is used to determine an algorithm by which the sample cartridge can be classified (e.g. pass, fail due to defect) based solely, or partly, on the one or more parameters/characteristics derived from the data sets from the one or more external sensors and expert labels (pass/fail tags for given images). It is appreciated that the algorithm may utilize one or more inputs, parameters in various combinations, as well as weighting of one or more parameters, or a relationship between parameters. Preferably, the algorithm (once trained on certain data sets) is applied in real-time during manufacturing so that cartridges determined to have defects can be removed from the production line. The automated detection methods described herein can complement or replace standard testing and inspection by personnel.

As shown in FIG. 1B, which shows another flowchart schematic 1100, the automated method can include obtaining one or more inputs of any number of parameters associated with manufacturing methods and processes. In this embodiment, the parameters can include, but are not limited to, any of: factory parameters (e.g. process parameters), incoming material parameters, specific process data (e.g. welder data), sensor data (e.g. optical RGB or IR imaging). These one or more inputs are fed into a ML model that analyzes the various input in combination with actual testing data (e.g. seal testing data) to determine an association between one or more parameters and a defect. In this embodiment, the ML model can include supervised and/or unsupervised learning, and can utilize seal test results and functional test results as labels to determine an algorithm by which the sample cartridge can be classified (e.g. pass/fail seal test failure, pass/fail functional). It is appreciated that the algorithm may be designed to associate the requirements of a given testing standard, for example the seal test failure (STF) test or a functional test.

As shown in FIG. 1C, a schematic overview 1200 of a system setup, the system is configured for capturing RGB and IR images of the cartridge lid during cartridge production. This setup includes an RGB camera 1110, light source 1111, optics 1112 that are configured to obtain the RGB image 1113. In this embodiment, the RGB image is obtained from a top view of the lid apparatus to detect defects in the lid construction (e.g. chimney features), although it is appreciated that various other views may be used from various other angles to assess these or other features as well. This setup also includes an IR camera 1120, which obtains an IR image 1121 of the lid. In this embodiment, the IR camera can be configured to obtain multiple sequential images 1122, 1123 before, during or after a process to assess the process, such as welding of the lid to the cartridge and/or film seal application.

As shown in FIG. 1D, the system infrastructure schematic 1300 is configured such that it is highly scalable for training and prediction data flow. For example, by utilizing cloud infrastructure and online storage, a web-based interface allows the data flow to be scaled up to include a vast amount of information, multiple systems and/or personnel, including personnel in remote locations. In this embodiment, the IR and RGB images are obtained during the manufacturing processes (e.g. during or after welding, or during film sealing) and the images are input to any suitable image monitoring/processing software (e.g. Thermal Process Monitoring System—TPMS), from which the data can be stored on cloud infrastructure or sent to online storage (e.g. Amazon S3), from which the data can be fed to an AI training model using any suitable software (e.g. DataRobot). The image data can also be sent to long term storage (e.g. Amazon Glacier). The image data can also input back into the programmable logic controller (PLC) of ROBAL, from which all other ROBAL data and meta-data can be input to an automation module using any suitable automation software (e.g. Ignition). IPT dashboard data (weight measurements from Seal Test Failure protocol, visual defect inspection results such as cracked/broken chimney) can also be input into the automation module, which in turn, outputs the automation data to a data sharing platform using any suitable software, including a cloud-based data sharing software, such as Snowflake, which can also receive input of functional test data from a QC SQL server, which in turn can be accessed by the AI training module. This setup allows the AI training module to be performed remotely from the ROBAL line by use of cloud-based infrastructure and data sharing. This setup allows the training to be scaled up to include larger data sets, optionally data from multiple ROBAL lines, and to be used by multiple personnel and sites. While particular specific software is referenced, it is appreciated that any suitable software may be used, and variations of the data flow depicted may be realized.

As shown in FIG. 1E, which shows a flowchart schematic 1400, trained simple models can be used to test the system. This flowchart can include inputs, such as IR and RGB images, welder time series and discrete value data, cartridge meta-data, and ROBAL sensor data, which are fed into supervised and unsupervised machine learning (ML) models. Labels can be applied, based on one or both of: IPT dashboard data, and functional test results. From these labels, the ML model determines a classification of the cartridges, which can include pass/fail prediction of STF and cartridge function.

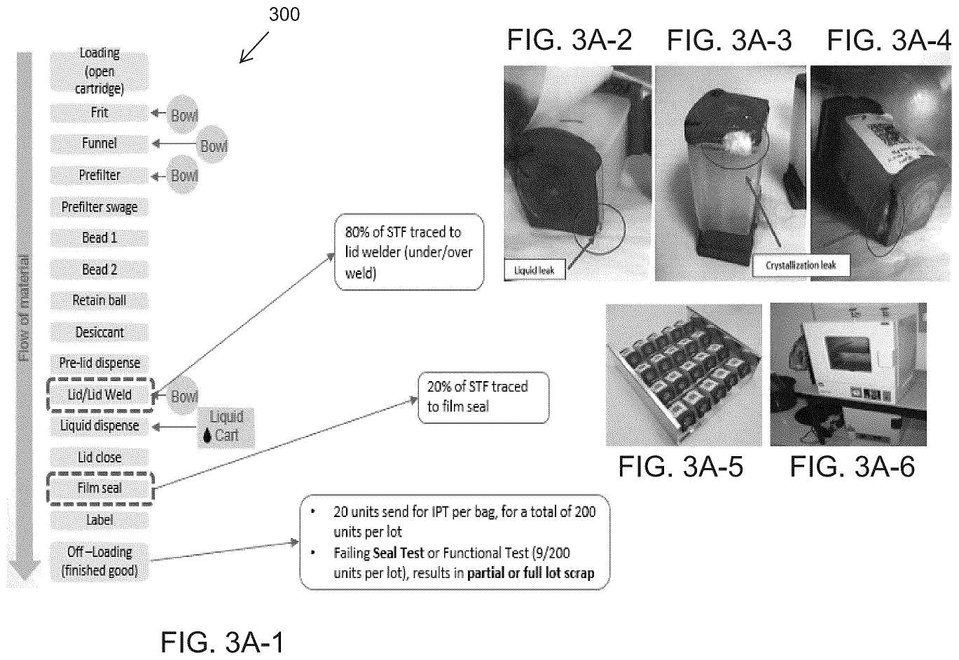

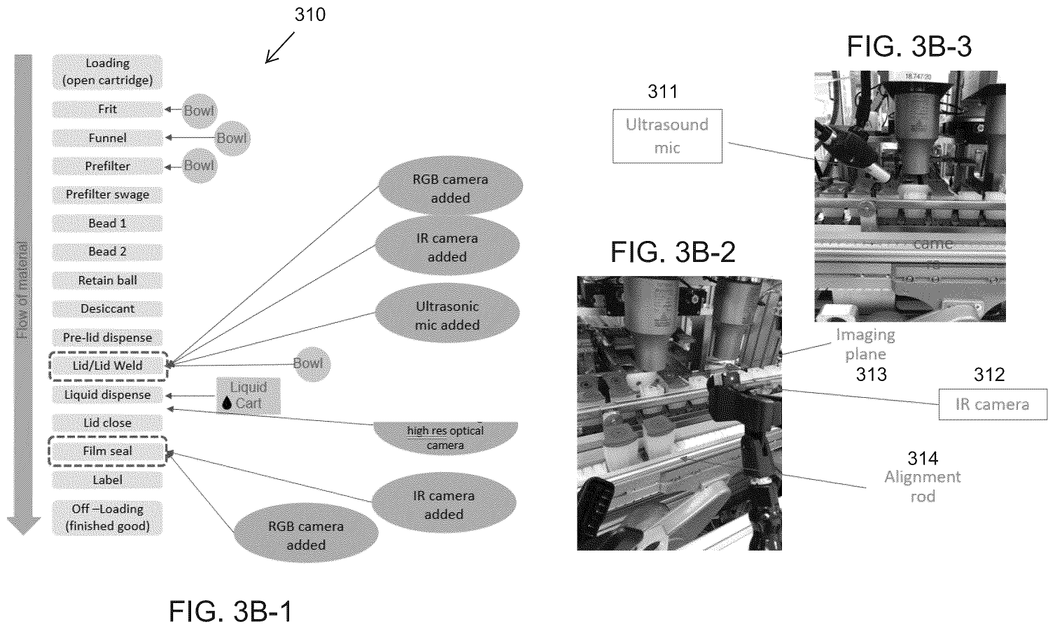

FIGS. 3A-I to 3A-6 show various sources of seal test failures. An exemplary manufacturing process flow 300 is shown at left. The process flow includes the lid welding and film seal steps that are often associated with defects that cause seal test failures. For example, 80% of seal test failures can be traced to the lid welding step (e.g. either under or over welding), and about 20% of seal test failures can be traced to the film seal step. Currently, defects caused by these steps are not detected until after the sample cartridges are labelled and off-loaded as a finished product, either by visual inspection by personnel or in a STF or functional test, which can result in a partial or full lot scrap. Accordingly, the automated detection systems and methods described herein can avoid this waste by allowing for detection of defects in real-time before the product manufacturing is completed by utilizing one or more external sensors positioned along the existing manufacturing process flow line. Thus, this approach described herein allows for improved defect detection, with minimal or no adjustment to the existing manufacturing line.

FIG. 3B-1 to 3B-3 show the manufacturing process flow line 310 with various external sensors added to an existing manufacturing line setup. In some embodiments, the lid welding step/station can include an optical RGB and/or IR camera that provides thermal imaging during welding to assess weld integrity. In some embodiments, an ultrasound microphone 311 can also be added to assess the weld based on sounds during welding. In some embodiments, an IR camera 312 is used to image along an imaging plane 313 and an alignment rod 314 can be used to ensure the cartridge is appropriately aligned in the imaging plane for imaging with the IR camera. The film seal step/station can also include an infrared camera that provides thermal imaging during welding to assess integrity of the thin film seal. A high-resolution optical camera can also be used to inspect the thin film alignment. The infrared cameras can be directed from any angle (e.g. an overhead view, angled view, a side view or any combination thereof). It is appreciated that any of these external sensors could be used individually or in combination with any other sensors at various other locations in the process flow line. It is understood that in order to implement this approach within the existing manufacturing process flow line, the external sensors can be synced or matched with operation of the existing process equipment for a given sample cartridge. This can be performed using existing cartridge tracking (e.g. by S/N) or various other approaches (e.g., RFID tags).

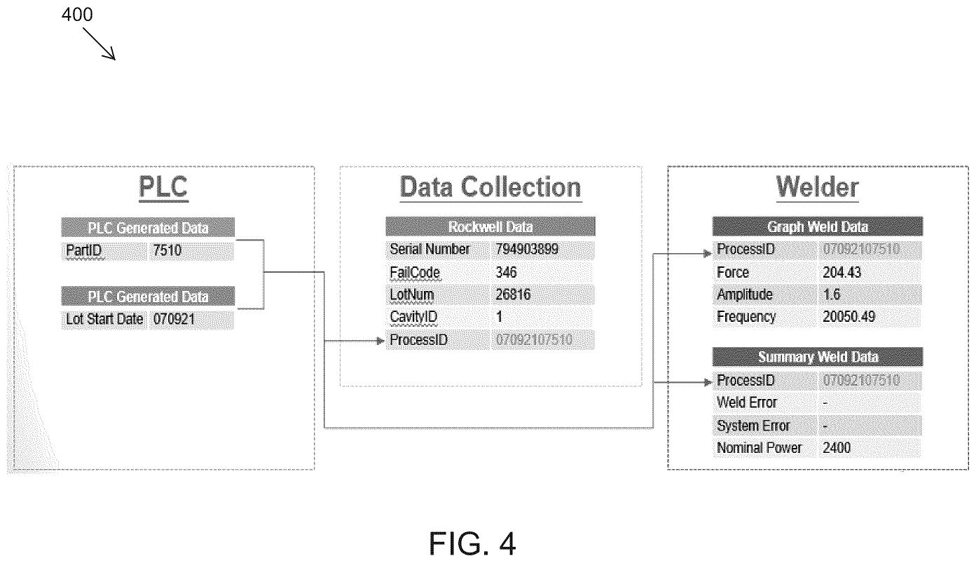

FIG. 4 shows a flowchart 400 that details one approach by which programmable logic controller (PLC) data is matched to welder data. There is no unique identifier matching automation data (e.g. Rockwell database) and welder data. During the weld process, the welder creates and assigns a Process ID to each weld. By combining a Part ID and lot state data, a unique Process ID can be created in the PLC and written to the welder by which the manufacturing line data can be matched to the welder data. It is appreciated this is but one approach by which to implement the automated defect detection method within existing manufacturing process data flow and that various other approaches could be used.

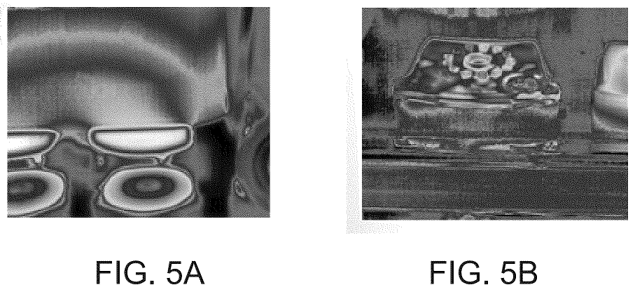

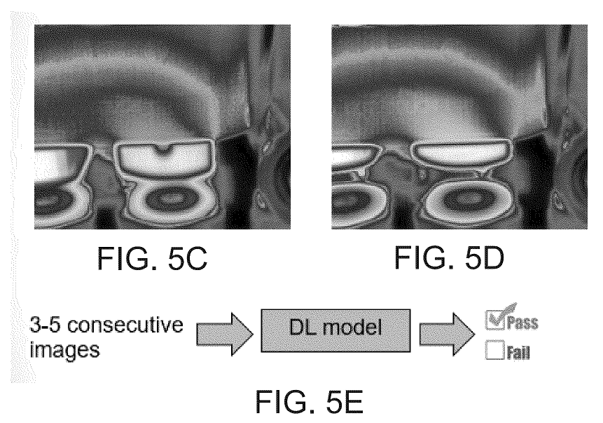

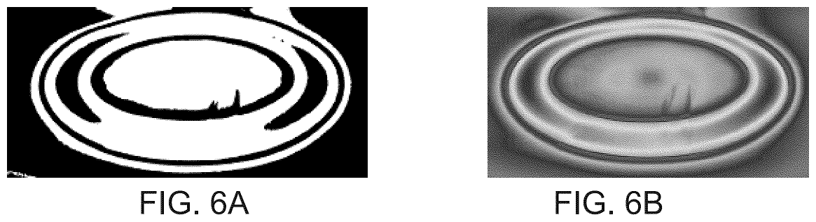

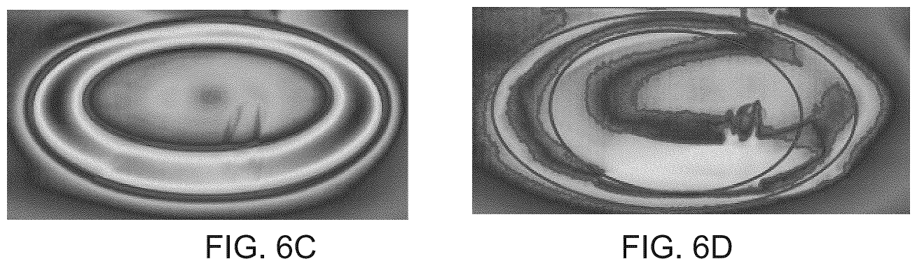

Infrared image data obtained during the weld and/or film heat sealing can be used to assess weld and seal integrity. Infrared imaging is advantageous over standard imaging as it contains additional thermal information during heating/cooling processes. In some embodiments, the infrared data can be used to assess a geometric fit, (e.g. fit an ellipse feature to seal area), provide statistics as to a temperature variation (e.g. cooling gradient within the seal ring over multiple images), and reveal inconsistencies in temperature (e.g. identify gaps, missing edge in seal). After analyzing multiple infrared images of standard manufacturing welding/thin film sealing of sample cartridges that pass post-manufacture sealing tests, a threshold can be determined for each feature/classification based on the respective feature. For example, a threshold can be determined for temperature variation along the seal, mismatch of the seal with an ellipse, etc. FIGS. 5A-5B show exemplary infrared images of the lid during the welding process, FIG. 5A showing a detail view of the inner seal of two adjacent cartridges captured with one IR camera at the film station. and FIG. 5B showing a perspective view of a lid on a cartridge. These IR thermal images can inform a thermal imaging model in a traditional computer vision approach, which can be used in a basic automated defect detection to detect the threshold to distinguish between a good vs. bad seal fit (e.g. FIG. 6C vs FIG. 6D). In some embodiments, the thermal imaging can be used to assess defects based on whether the thermal imaging is within the desired range, which can be determined by analyzing experimental results, with or without the aid of machine learning. Advantageously, a ML model allows for consistent identification of characteristics and parameters associated with defects.

In another aspect, the images can be a series of consecutive images (e.g. a video of a few seconds or less, including skipping over images in between), which produces more data from which the welding or sealing operation can be characterized by including temporal temperature gradients during cooling/heating. Given the more expansive data set, this approach greatly benefits from use of a ML model. In some embodiments, the image sequence comprises at least 3-5 consecutive images (e.g. a short video of a few seconds or less), which are fed into a ML model. In some embodiments, the ML model is a deep learning (DL) model, which determines a relationship between consecutive progression of images and seal test failure by combining feature extraction and detection steps in one complex model (contrary to separate models for feature extraction, e.g., Histogram of Oriented Gradients and detection, e.g., Support Vector Classifier). An example of consecutive images during the welding operation are shown in FIGS. 5C-5D, and a process schematic is shown in FIG. 5E, depicting an exemplary process flow for automated defect detection, in which 3-5 consecutive images are input into a deep learning (DL) model, which outputs a cartridge classification as pass or fail.

In another aspect, the IR images can be fit on a domain-knowledge specific model of the contours of shape of the lid features (e.g. outline, individual chimneys, central opening, etc.) to assess the integrity of the features or a seal surrounding these features. In some embodiments, these contours are extracted from a binary image and fit onto a corresponding shape (e.g. ellipse corresponding to a circular opening imaged from a perspective view). The temperature distribution within the shape can be analyzed and a pass/fail criterion (e.g. threshold) formulated. If the residual for an ellipse fit is above the criterion/threshold, then the sample cartridge fails, and if the ellipse with residual is below the threshold for multiple consecutive frames with homogeneous minimum temperature, then the sample cartridge passes. An example of this ellipse fit is shown in FIGS. 6A-6E. FIG. 6A shows the extracted binary image of the contour (ellipse) and FIG. 6B shows the thermal distribution fit onto the extracted binary image. FIG. 6C shows an acceptable contour fit (pass) between elliptical shapes (blue) and contours (red) (residual ellipse 1:0.02 and residual ellipse 2:0.04) indicative of a pass, and FIG. 6D shows an unacceptable contour fit (fail) (residual ellipse 1:0.32 and residual ellipse 2:0.29) indicative of a fail. Thus, FIGS. 6A-6D show feature extraction for defect detection by applying domain knowledge (e.g. elliptic seal shape) in contrary to automated feature extraction in deep learning. FIG. 6A is a binary image, FIGS. 6B-6C indicates a good shape fit, and FIG. 6D indicate a bad fit shape (potential defect).

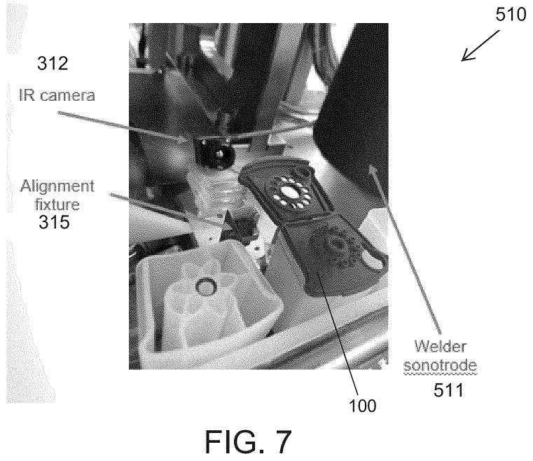

FIG. 7 shows a welding station 510 with an external sensor, an IR camera 601, adjacent the cartridge 100 below the welder sonotrode 511 (welder #1) for welding the lid apparatus to the sample cartridge body. An alignment fixture 315 is used for aligning the lid apparatus and cartridge before welding. In this embodiment, the IR image is obtained from behind and below cartridge by the IR camera 312 to determine the completeness of the weld. The space behind the existing welder was sufficient to mount IR camera 2000 on the alignment fixture 2050 for purposes of this feasibility study. Notably, the alignment fixture moves before and after the weld. If the space behind a welder (e.g. welder #2) is constrained, IR detection can be performed by fiber optics.

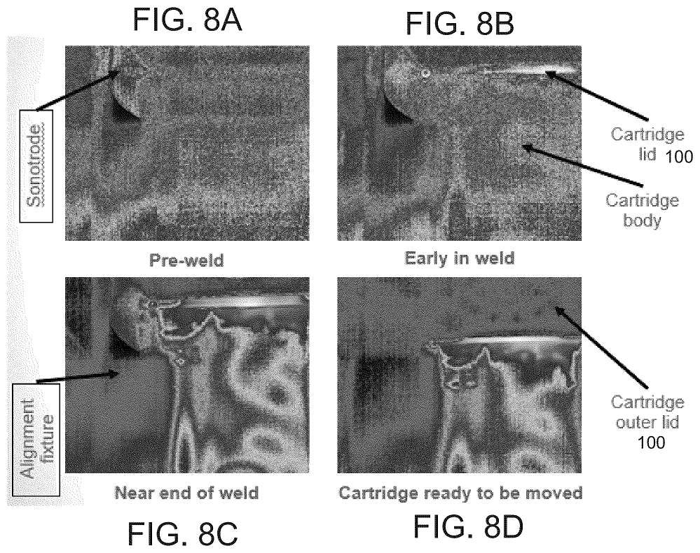

FIGS. 8A-8D shows IR thermal imaging during the weld when the IR camera is positioned behind/below the lid (as shown in FIG. 7). FIG. 8A shows a pre-weld IR image, FIG. 8B shows an IR image early in the weld process, FIG. 8C shows an IR image near the end of the weld process, and FIG. 8D shows an IR image post-weld when the cartridge is ready to be moved further along the manufacturing line. These images clearly show the rear edge of cartridge lid/body heating up during weld. The cartridge body is not sufficiently IR-transparent to image all the desired weld edges. Therefore, it may be advantageous to utilize additional IR cameras or a top-down view IR camera, or use multiple IR cameras from different angles, or RGB cameras to provide additional data sets.

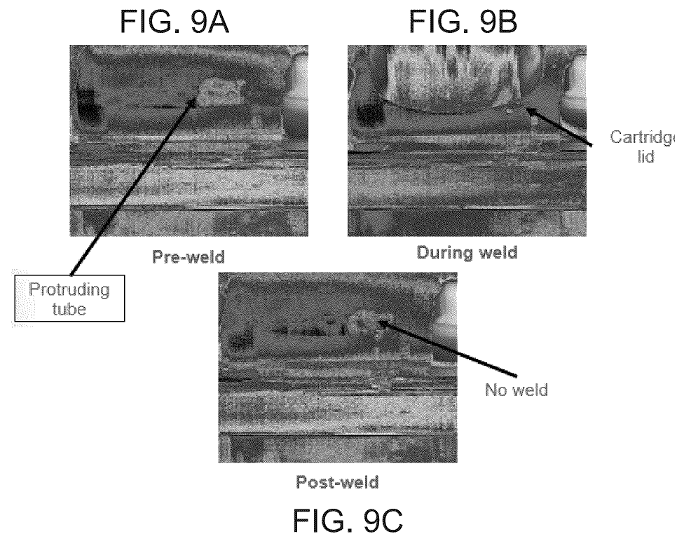

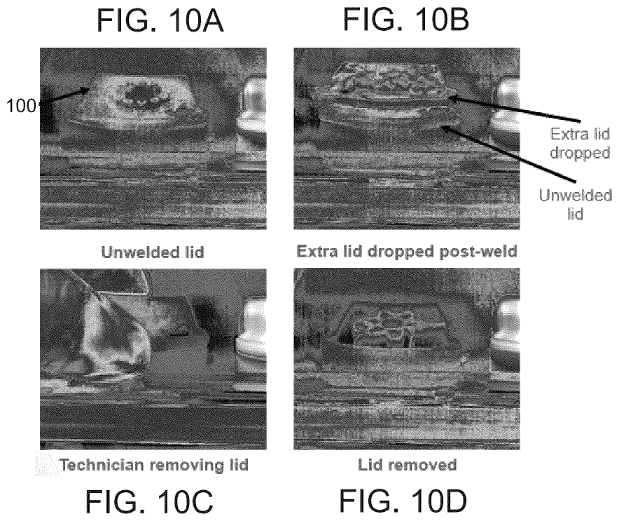

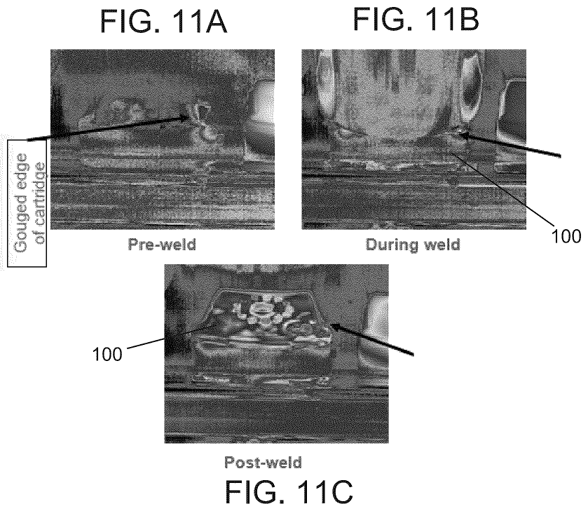

FIGS. 9A-9C shows defect detection through consecutive IR images. FIG. 9A shows an IR image obtained pre-weld, FIG. 8B shows an IR image obtained during welding, and FIG. 9C shows an IR image post-weld. In this case, the defect is a bad weld from a protruding sample tube, which results in seal failure. This gross fault was introduced by sticking a protruding tube in the sample cavity, such that a “no weld” area is seen as that area of the lid does not heat up or weld to the cartridge body. FIG. 10 shows another defect detection through consecutive IR images. In this case, the defect is a gross fault caused by an extra lid dropped before welding. FIG. 10A shows an IR image of an unwelded lid, FIG. 10B shows an IR image after the extra lid is dropped post-weld, FIG. 10C is an IR image obtained as a technician removes the extra lid, and FIG. 10D is an IR image after removal of the lids. FIG. 11 shows yet another defect detection through consecutive IR images. In this case, the defect is gross fault induced by a gouge in the cartridge body prior to weld such that welding occurred but is not continuous around the lid. FIG. 11A is an IR image obtained pre-weld, FIG. 11B is an IR image obtained during welding showing the lid edge heating up (see arrow), and FIG. 11C is an IR image obtained post-weld showing no discontinuity at edge (see arrow).

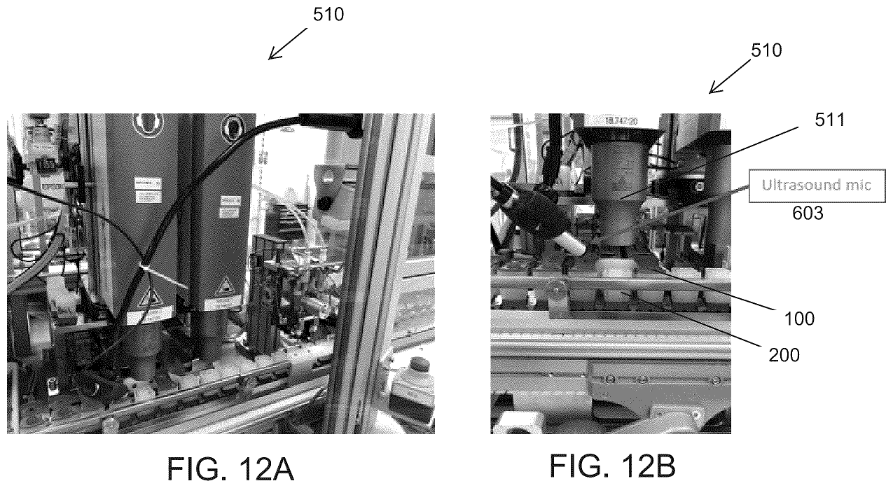

In another aspect, the sound produced during a welding/sealing operation can be recorded and analyzed to determine manufacturing defects. Similar to the IR images discussed above, sound recording during the operation of successful cartridges and failed cartridges can be analyzed and a threshold/range of audio for successful cartridges determined and/or sound characteristics of failed cartridges determined. Notably, the microphone can include the ultrasound range so as to detect sound variations associated with ultrasonic welding. FIG. 12A shows a welding station 510 where two welders (welder #1 and #2) are disposed atop an assembly line of cartridge bodies to be welded with lids. FIG. 12B shows the ultrasound microphone 603 positioned adjacent the welder 511 at the ultrasonic welding station 530. In this embodiment, the microphone is a 96 kHz bandwidth microphone, but any suitable microphone could be used. The microphone is positioned suitably close (e.g. ˜2″) from the top of cartridge where the weld occurs. Multi-Instrument software can be used to record the sound data.

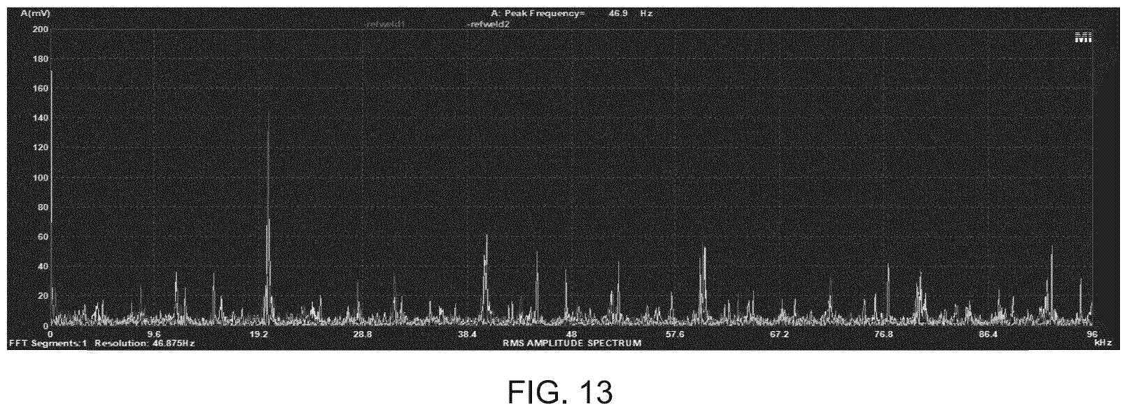

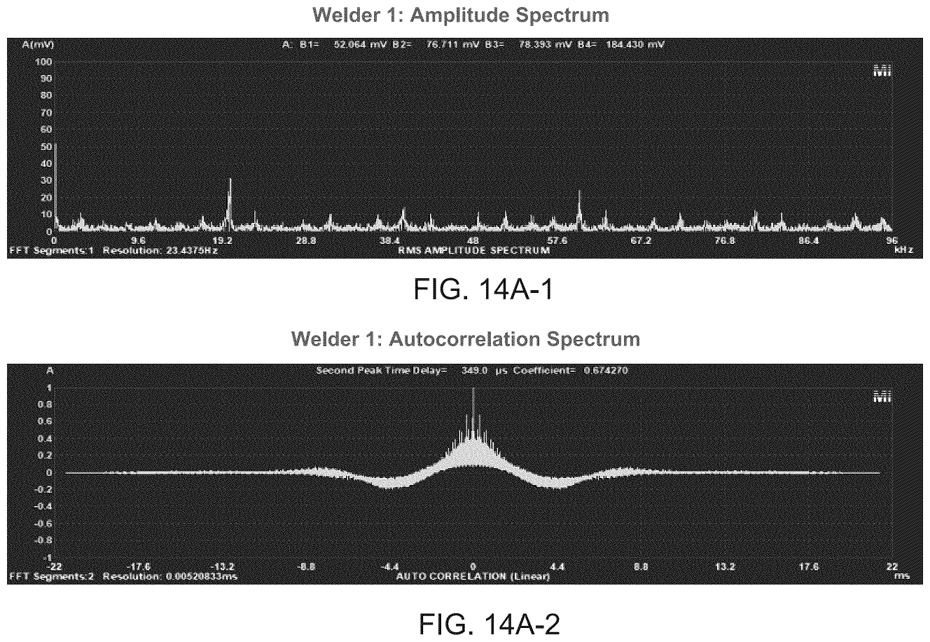

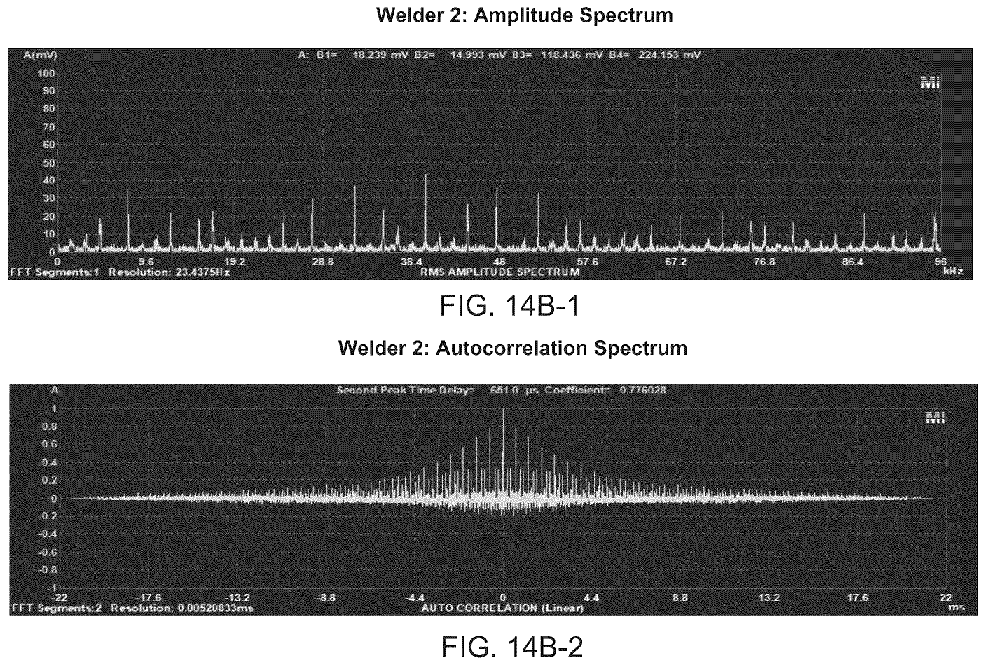

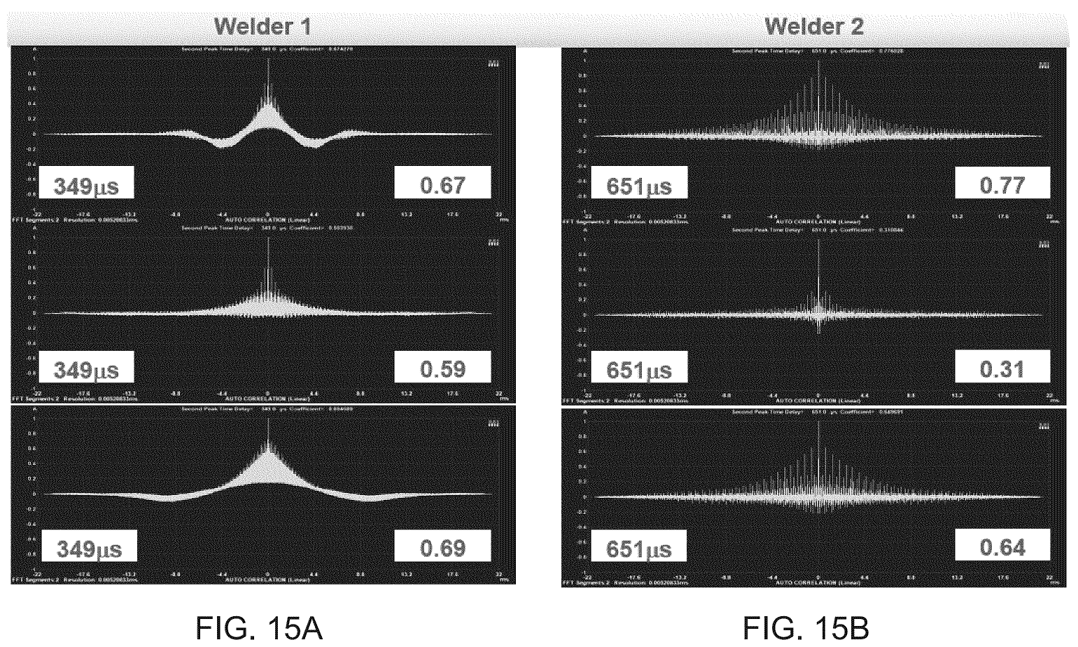

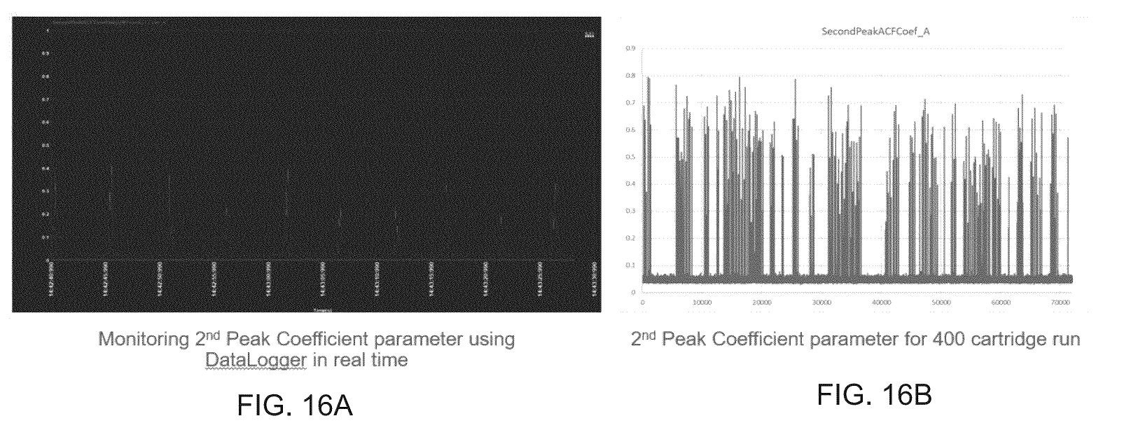

FIGS. 13-16B show sound spectrums and analysis from the ultrasound microphone that demonstrate sound characteristics of the welding operation that can be utilized in defect detection as described above. FIG. 13 shows the amplitude spectrum comparison in which the weld process on both welders #1 and #2 is detected and distinct signatures of left and right welds can be seen. The fundamentals are ˜100 kHz apart but, as shown, the harmonic content is very different. FIGS. 14A-1, 14A-2, 14B-1 and 14B-2 show an auto-correction analysis, which improves characterization of harmonics in the data. The second peak time delay is tracked and a coefficient to characterize the auto-correlation spectrum is determined. This is a more robust method to characterize response as the fundamental frequency is not always detected. FIG. 14A-1 shows the amplitude spectrum and FIG. 14A-2 shows the autocorrelation spectrum for welder #1. FIG. 14B-1 shows the amplitude spectrum and FIG. 14B-2 shows the autocorrelation spectrum for welder #2. FIGS. 15A and 15B show an auto-correlation spectra for determining weld-to-weld consistency for welder #1 and #2, respectively. The spectra show some differences but the second peak time delay seems a consistent basis for identification of the weld. While some minor variation between the welds can be expected, a variation beyond a pre-determined threshold/range can be indicative of a weld defect. FIGS. 16A and 16B show tracking of the weld parameters in real-time using a data logger feature in a multi-instrument software. This can be used to determine consistency of detectability over 100 sec of welds verified for different weld energy levels and lid/cartridge combinations.

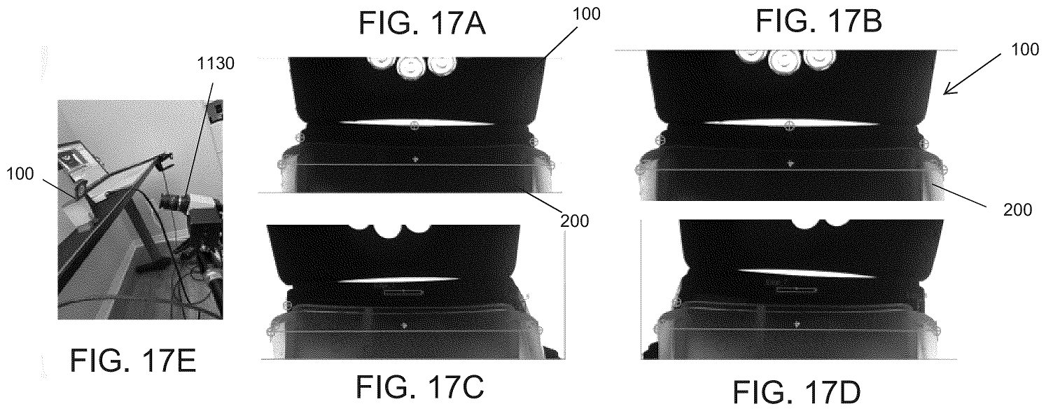

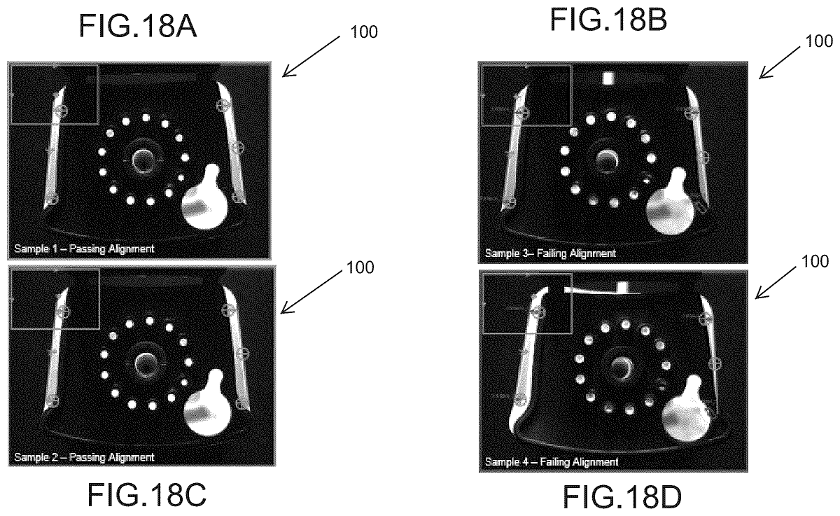

In yet another aspect, high-resolution optical cameras can be used to detect variations in visible features during or after the manufacturing process to identify defects in real-time. FIGS. 17A-17D and FIGS. 18A-18D show images from a high-resolution optical camera to detect lid alignment issues and associated system setup. As shown in FIG. 17E, a high-resolution camera 1130 (e.g. Cognex In-Sight 8402) was positioned to detect lid alignment from a rear view of the cartridge lid 100. The cartridge shoulders were referenced to determine alignment of the lid relative the cartridge body. FIGS. 17A-17D shows a series of images of different cartridges, the upper two images (FIGS. 17A-17B) showing acceptable lid alignment (pass), and the lower two images (FIGS. 17C-17D) showing unacceptable lid alignment outside the pre-determined threshold (fail). FIGS. 18A-18D show another approach by which the high-resolution optical camera is positioned from a top-down view for defect detection of lid misalignment. FIGS. 18A and 18C demonstrate a suitable lid alignment (pass), while FIGS. 18B and 18D demonstrate an improper lid alignment (fail). It is appreciated that various mismatch features may not be readily apparent when viewed by personnel, such that image analysis techniques can be used to identify the number and nature of lid alignment defects. Additionally, an ML/DL model can be used to determine a relationship of optical features that are associated with lid alignment defects. Additionally, it is appreciated this approach can also be used not only with lid alignment, but various other features for defect detection (e.g. welds, cartridge body construction, thin film seal integrity, etc.).

In yet another aspect, imaging can further include optical RGB cameras, which are standard CMOS sensors that detect light from the visible spectrum and produces images by an RGB color model, which is an additive color model in which the red, green and blue primary colors of light are added together. RGB cameras can identify characteristics that may not be shown with IR images and vice versa. In some embodiments, the automated defect system and methods utilize RGB and IR images, and can utilize any of the approaches above in regard to threshold/range determination, including use of images and consecutive images in a ML model. In some embodiments, the automated methods utilized both RGB and IR images to obtain additional data from which the ML model can more accurately detect defects.

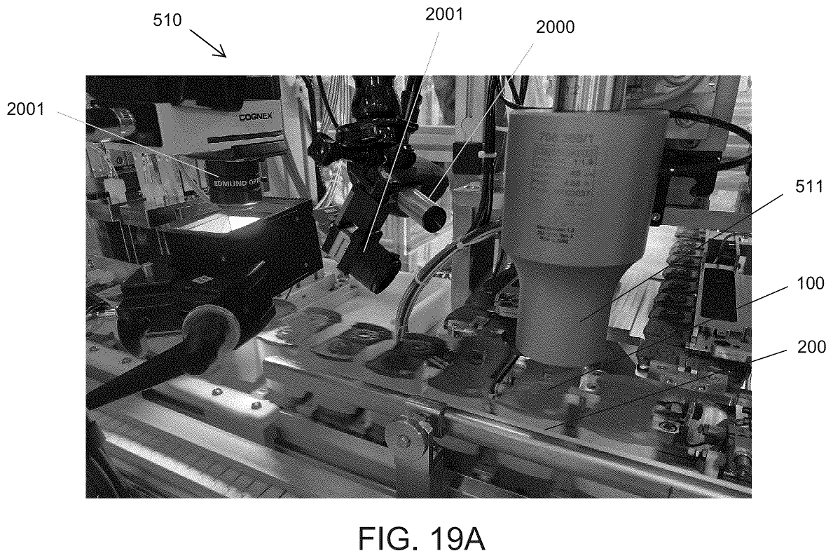

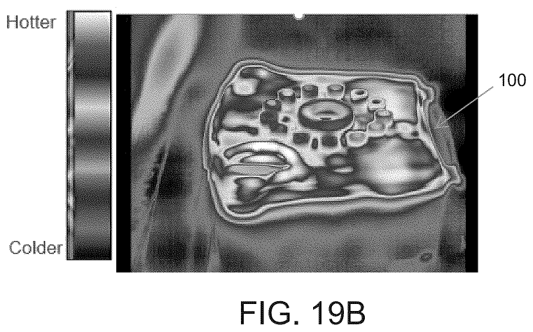

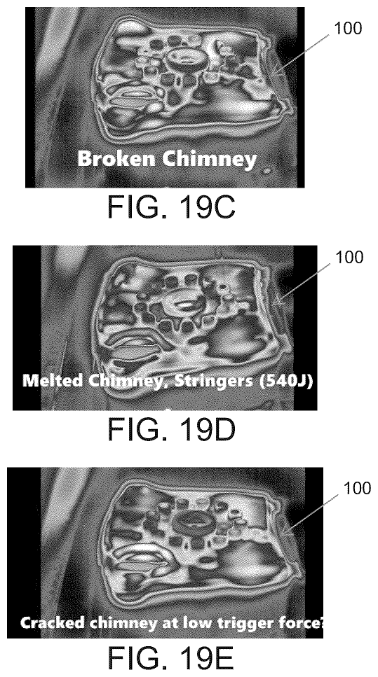

FIG. 19A shows a lid welding station 510 with RGB camera 2001 and IR cameras 2000 directed at the sample cartridge lid 100 atop the cartridge body 200 before welding of the lid to the cartridge body with the ultrasonic sonotrode 511. It is appreciated that RGB cameras can similarly be placed at various other locations/angles, for example, a top-down view at a post-weld position, such as imager 2001, and can also be placed at the film heat seal station. The RGB and IR cameras can be used to capture any of: a weld plan heat signature at the welding station during welding, a high resolution top-down optical image post weld, and a film heat signature at the film station. Features can be extracted from the one or more images using classical computer vision techniques (e.g. Histogram of Oriented Gradients). The images were obtained for multiple cartridges which were subsequently subjected to standard seal tests and visual inspection. The resulting outcome was that the computer vision system, utilizing the RGB and/or IR images successfully identified cartridge defects associated with seal test failures using a classifier model (e.g. Support Vector Machine). The defects that can be detected by RGB and/or IR images by these methods includes any of: a broken chimney (i.e. cylindrical protruding lid feature), a cracked chimney, a poor film seal, a melted chimney and underwelds. In some embodiments, the broken or cracked chimney and underweld are detected at the welder station, and the poor film seal and melted chimney are detected at the film seal station. Testing indicated that the RGB and IR images were able to identify defects associated with seal test failure that were not identified by human visual inspection. Examples of RGB and IR images that were able to detect these defects are shown below in FIGS. 19A-19D.

FIG. 19B shows a baseline IR image of a lid showing a thermal distribution of a successful weld, as confirmed by subsequently performed standard seal testing and visual inspections. FIGS. 19C-19E show IR images of a lid that depart from the baseline image in a characteristic manner that was determined to be associated with various defects as confirmed by subsequently performed seal testing and inspection. FIG. 19C shows an IR image showing a thermal distribution indicative of a broken chimney. FIG. 19D shows an IR image showing a thermal distribution indicative of a melted chimney. FIG. 19E shows an IR image showing a thermal distribution indicative of a cracked chimney.

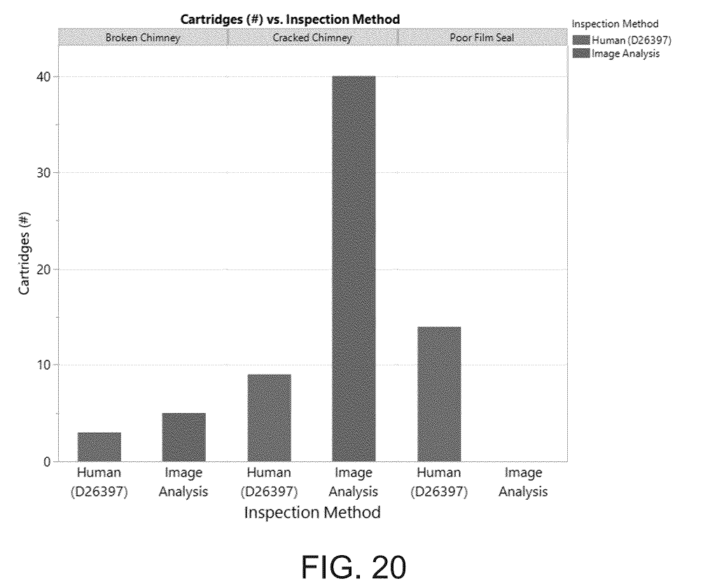

FIG. 20 shows experimental results of defect detection with image analysis versus standard human inspection. The RGB and IR images allow the system to identify in-situ failure modes that can otherwise only be identified with substantial testing. Image analysis identified broken and cracked chimneys and was more effective than a technician using high-resolution optical microscope (e.g. VHX). Seal test failures due to poor seal were not consistently identified by IR image analysis alone, however, the additional data provided by high-res RGB cameras post film seal can better identify this defect.

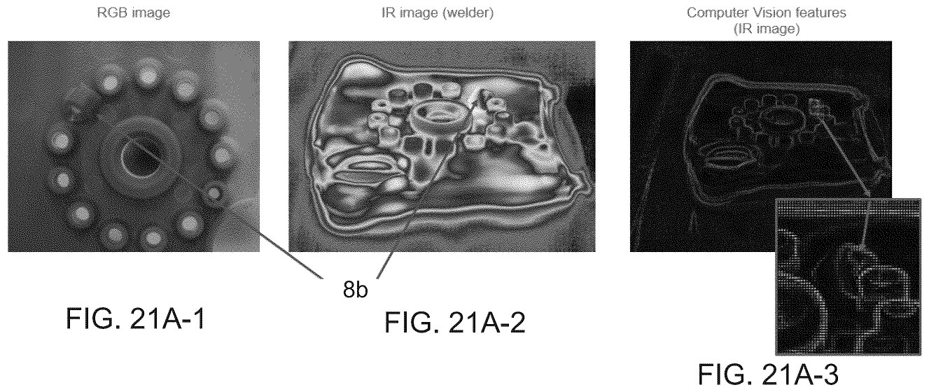

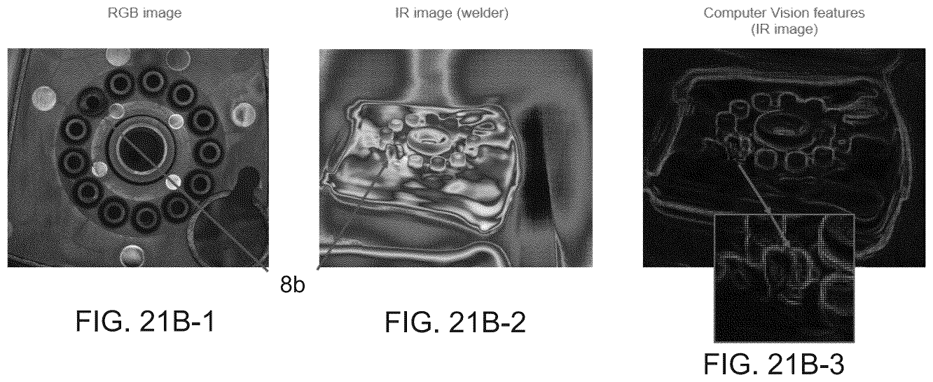

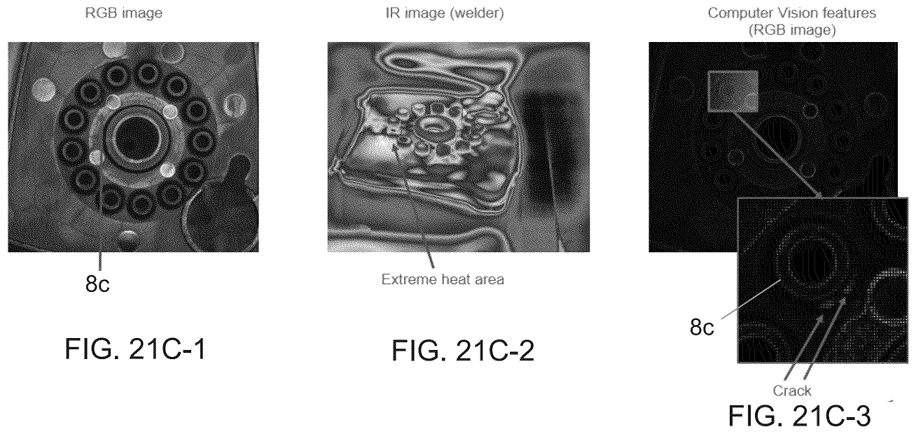

FIGS. 21A-1 to 21A-3 show an overhead RGB image of the lid (FIG. 21A-1), a perspective IR image at the welder (FIG. 21A-2), and a computer vision analysis of the IR image (FIG. 21A-3), which were able to identify a broken chimney 8b by image analysis in the manufacturing line. The broken chimney was confirmed by subsequent standard seal testing and visual inspection.

FIGS. 21B-1 to 21B-3 show an overhead RGB image of the lid (FIG. 21B-1), a perspective IR image at the welder (FIG. 21B-2), and a computer vision analysis of the IR image (FIG. 21B-3), which were able to identify another broken chimney 8b by image analysis in the manufacturing line, even when the broken chimney was not able to be identified during standard testing, including visual inspection. Thus, the RGB and IR images are more sensitive than existing defect detection tests/inspections.

FIGS. 21C-1 shows an overhead RGB image of the lid (FIG. 21C-1), a perspective IR image at the welder (FIG. 21C-2), and a computer vision analysis of the RGB image (FIG. 21C-3), which were able to identify a cracked chimney 8c by image analysis in the manufacturing line. The broken chimney was confirmed by subsequent standard seal testing and visual inspection.

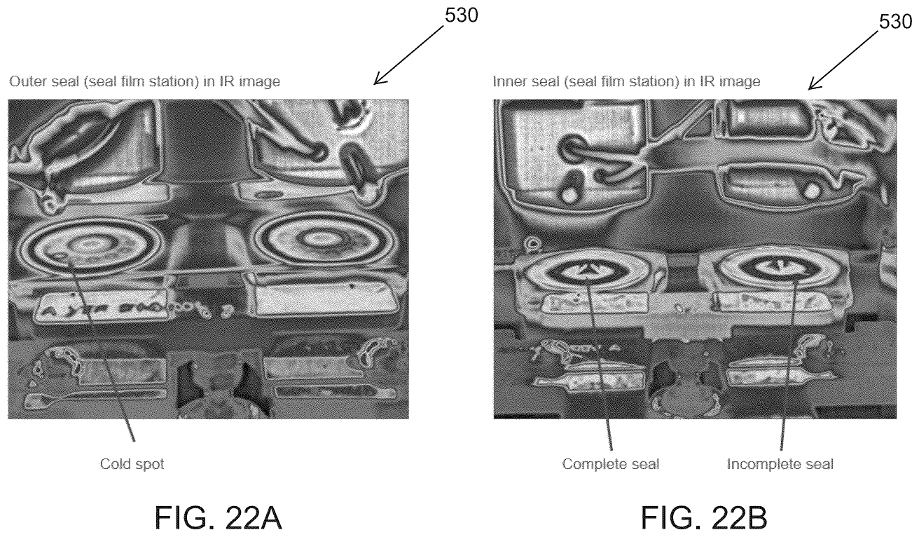

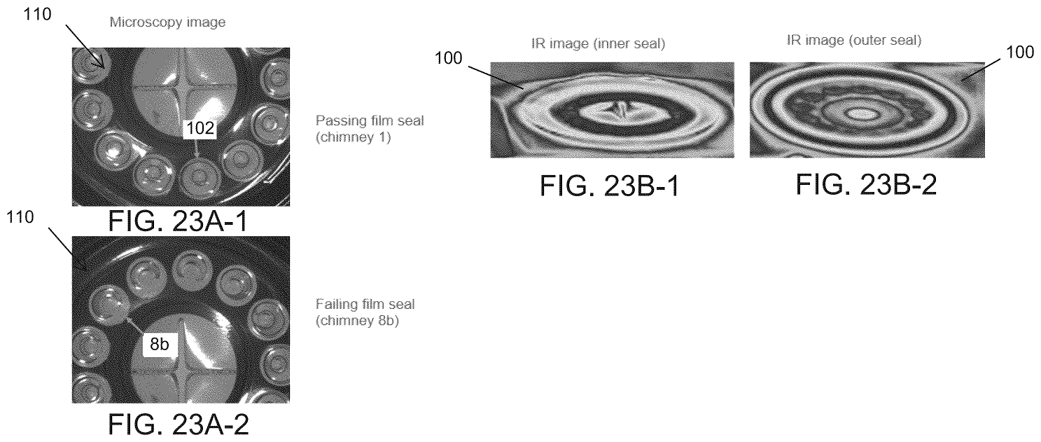

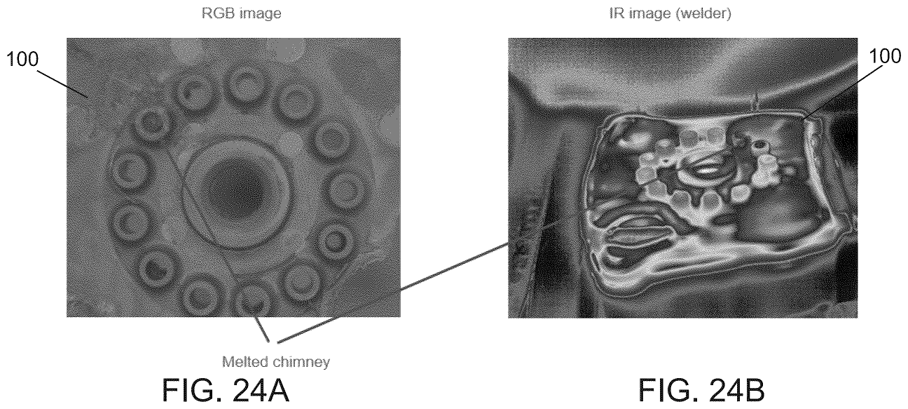

FIGS. 22A-22B shows thin film seal anomalies as detected by IR images at the seal film station 530. FIG. 22A shows a cold spot in the outer seal (surrounding the ring of chimney openings), and FIG. 22B shows an incomplete seal at the inner seal (inside the ring of chimney openings). Each of these film defects were not detected by standard film seal testing and visual inspection. FIGS. 23A-1 and 23A-2 show microscopy images that can also be used in film seal analysis, in particular, a passing film seal (chimney 102 in FIG. 23A-1), and a failing film seal (chimney 8b in FIG. 23A-2). These particular defects were not shown in the IR FIGS. 23B-1 and 23B-22. Accordingly, the thin film detection can be further improved by including additional data sets, for example, by any of the following additions: an RGB camera after the seal station, a higher resolution IR camera for the seal station, a top-down IR camera after the seal station, and a visual chimney ratio estimation. FIG. 24A shows an RGB image (top view of lid at left), and FIG. 24B shows an IR image (perspective view at welder station), which detected a melted chimney, a feature which was not identified by standard seal testing, but was identified during a subsequent visual inspection. The above experimental results indicate that image analysis with IR and/or RGB images are routinely able to identify certain defects associated with seal test failure, even defect that are not routinely detected by standard seal testing and visual inspections. Thus, automated defect detection with image analysis, in particular, with IR images, RGB images, or both IR and RGB provide improved, more consistent detection of manufacturing defects.

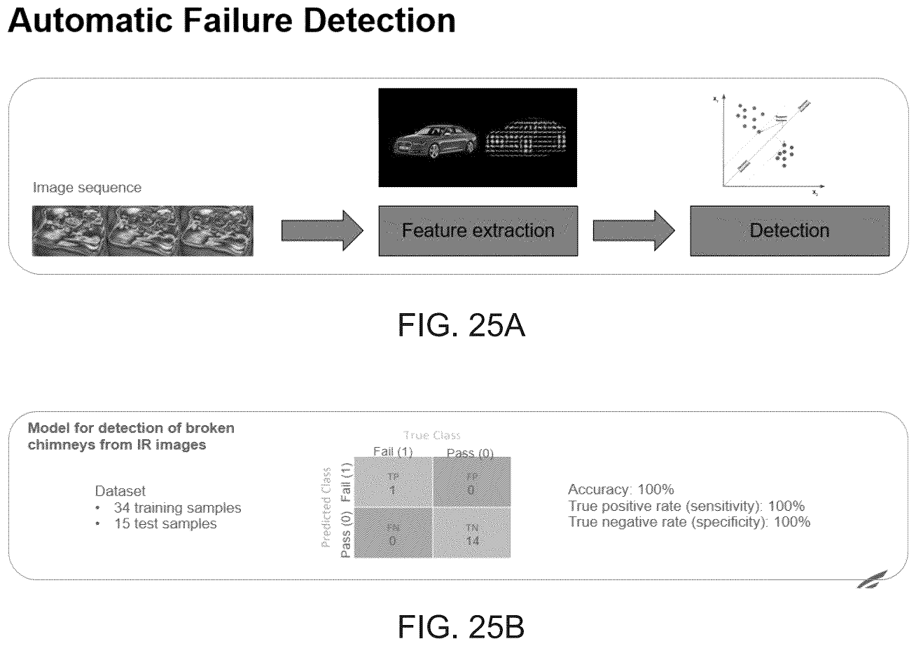

FIG. 25A shows a schematic of automatic failure detection based on the imaging approaches described above. At left, the system obtains images, or sequence of images (e.g. IR/RGB images), features are extracted, and the extracted features are compared to a corresponding baseline image for detection of defects associated with seal test failure. FIG. 25B shows a basic ML model by which a defect (e.g. broken chimneys) can be obtained from a sequence of IR images with high accuracy. FIGS. 25A-25B refer to a modular failure detection algorithm that can be used combining computer vision for feature extraction (e.g., Histogram of Oriented Gradients) and classical Machine Learning (e.g. for classification of defects based on extracted features with Support Vector Machine). In some embodiments, Deep Learning is being used in an end-to-end approach (combining feature extraction and detection by Deep Neural Network classifier). It is appreciated that both these approaches can be used.

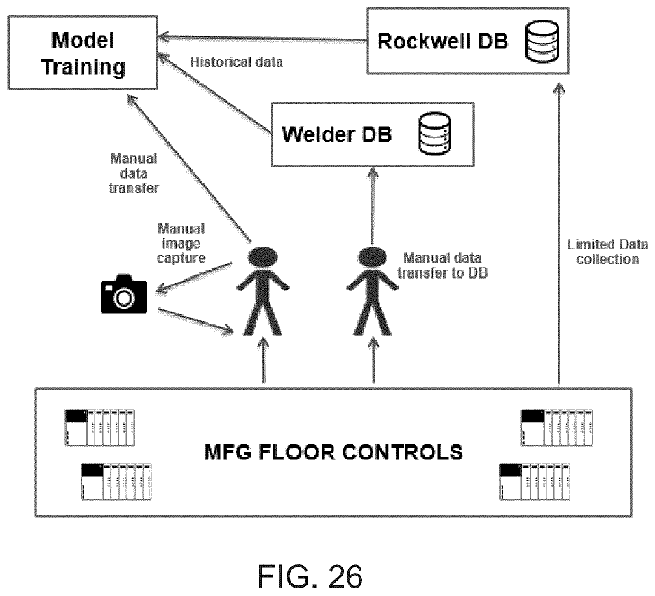

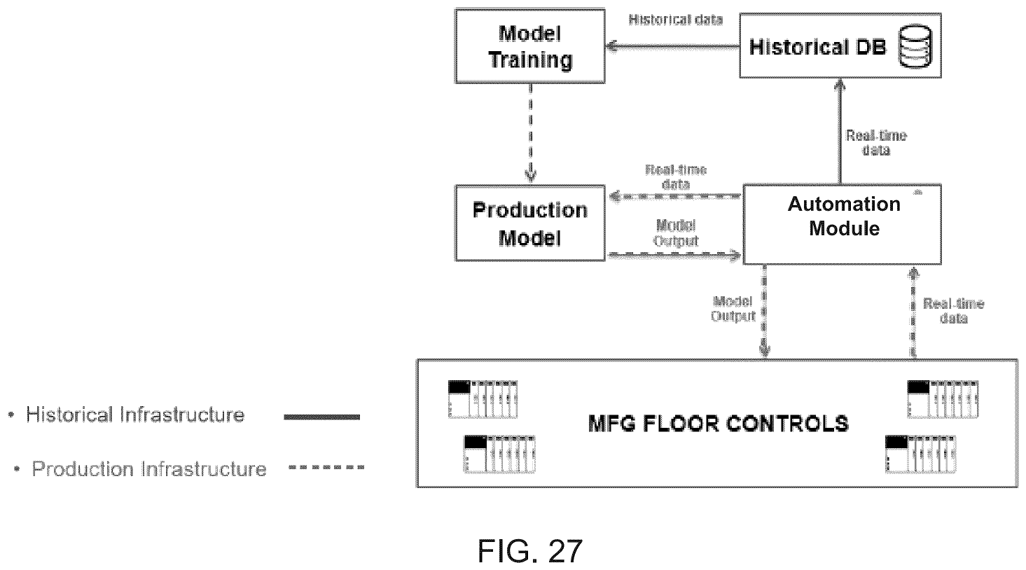

It is appreciated that the infrastructure of the manufacturing process can affect the ability to obtain data for use in automated defect detection utilizing a ML model. FIG. 26 shows current infrastructure limitations, in which manual data is transferred to a database and manual image capture is fed back into the ML model. The features shown represent historical infrastructure in current systems. FIG. 27 shows an integrated manufacturing data infrastructure. In some embodiments, a ML model is incorporated into the data collection systems and is automated such that the defect detection occurs in real-time during manufacturing such that defective units can be removed during manufacturing, rather than requiring testing after manufacture is complete. Additionally, this approach allows for quick identification of issues that could potentially affect multiple sequential units that would have adversely impacted an entire lot, thereby allows any issues to be quickly resolved and manufacturing resumes so as to avoid repetition and decrease defects and wasted products. The historical infrastructure is represented by solid lines. The historical infrastructure can be integrated into the improved systems utilizing machine learning models. The current infrastructure automates data collection and storage, provides a single point of truth for manufacturing data and can be readily scaled to incorporate more tools and/or differing data sources. The production infrastructure is represented by dashed line. The production infrastructure provides a one-center hub for data on the manufacturing plant floor, can publish real-time PLC data that is accessible through APIs and other open protocols, and automate production data streams and low latency communication. Thus, the system and methods provided herein ideally leverages existing historical infrastructure and production infrastructure, utilizing automation data in identifying defects and/or classifying cartridges and feed these classifications back into the production process.

FIG. 26 shows a current infrastructure of the automated manufacturing process which have limited data collection that can be used for automated defect detection. In this setup, manual data is still transferred from the manufacturing floor controls to the welder database and additional image capture data would be manually transferred back to the model training. Data from the automation software is also fed back to the ML model. This approach can therefore provide for improved defect detection utilizing the imagine techniques with minimal or no changes to the existing manufacturing process line.

FIG. 27 shows a schematic with an improved manufacturing infrastructure setup that is integrated with the automatic defect detection features described herein. In this infrastructure, the real-time data and imaging data does not rely on manual transfer, but instead if transmitted in real-time from the manufacturing floor controls to an automation control software (e.g. Ignition) such that the real-time data is automatically transferred, in real-time, to the ML model for defect determinations, which in turn, are fed as outputs back to the automation software such that the manufacturing processes can be modified as needed or defective units can be discarded automatically without interfering with ongoing manufacturing processes. This automated data collection allows scaling to big data which is typically a requirement for Deep Learning models. It is appreciated that this is but one data infrastructure for integration of automated defect detection within an automated manufacturing process and that various other configurations can be realized.

In the foregoing specification, the invention is described with reference to specific embodiments thereof, but those skilled in the art will recognize that the invention is not limited thereto. Various features, embodiments and aspects of the above-described invention can be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art. Any references to publication, patents, or patent applications are incorporated herein by reference in their entirety for all purposes.

1. A method of detecting a defect in a sample cartridge, the method comprising:
obtaining one or more data sets from one or more external sensors during a manufacturing process of a sample cartridge;
comparing one or more data sets to a baseline data set of the manufacturing process and/or sample cartridge, the baseline being associated with acceptable sample cartridges; and
identifying a defect of the sample cartridge based on a variance of the one or more data sets from the baseline.

2. The method of claim 1 wherein the defect is determined in an automated process in real-time during manufacturing of the sample cartridge.

3. The method of claim 1 wherein obtaining one or more data sets comprises obtaining a plurality of images from one or more RGB cameras and/or IR cameras, wherein the one or more data sets comprise a thermal image.

4. The method of claim 3 wherein identifying based on a variance utilizes an algorithm derived by machine/deep learning based on a plurality of data sets associated with acceptable sample cartridges and a plurality of data sets associated with cartridge defects.

5. The method of claim 3 further comprising:
extracting a feature from the one or more images that corresponds to a feature of the sample cartridge.

6. The method of claim 3 wherein the one or more data sets comprise a plurality of consecutive images obtained during the manufacturing process.

7. The method of claim 1 wherein the one or more data sets comprise a plurality of image from differing viewpoints during the manufacturing process.

8. The method of claim 1 wherein the manufacturing process comprises ultrasonic welding of a lid apparatus on a cartridge body of the sample cartridge.

9. The method of claim 1 wherein the manufacturing process comprises heat sealing of a thin film atop the lid apparatus on the cartridge body of the sample cartridge.

10. The method of claim 1 wherein the one or more external sensors comprise an RGB camera.

11. The method of claim 1 wherein the one or more external sensors comprise an IR camera.

12. The method of claim 1 wherein the one or more external sensors comprise an ultrasound microphone.

13. The method of claim 12 wherein the one or more data sets further comprise an ultrasound audio spectrum that is compared to a baseline of ultrasound audio of a successful weld, wherein the characteristic comprises peaks and/or variations in the ultrasound audio spectrum.

14. The method of claim 1 wherein the one or more external sensors comprise a high-resolution camera that obtains a high-resolution optical image.

15. The method of claim 1 wherein the variance comprises a deviation of an extracted feature from a corresponding feature of a baseline high-resolution image.

16. The method of claim 1 wherein the data sets are input into a model that classifies the sample cartridge as pass or fail based on a defect prediction.

17. The method of claim 16 wherein the model is trained based on supervised and unsupervised machine learning.

18. The method of claim 16 wherein the model accesses the data sets through a cloud-based data sharing, training and prediction platform.

19. The method of claim 1 wherein the data sets are obtained from an automation module of the automated manufacturing line of the cartridge.

20. The method of claim 1 wherein the one or more external sensors comprise an RGB camera and an infrared camera.

21.-41. (canceled)
